(19) United States
(12) Patent Application Publication
(10) Pub. No.: US 2014/0313315 A1
(43) Pub. Date: Oct. 23, 2014

(54) METHOD AND SYSTEM FOR TRANSMITTING LIGHT

(71) Applicant: Technion Research & Development Foundation Limited, Haifa (IL)

(72) Inventors: Shy Shoham, Haifa (IL); Hod Dana, Ashburn, VA (US)

(73) Assignee: Technion Research & Development Foundation Limited, Haifa (IL)

(21) Appl. No.: 14/358,255

(22) PCT Filed: Nov. 15, 2012
(86) PCT No.: PCT/IB2012/056464

§ 371 Date: May 15, 2014

Related U.S. Application Data
(60) Provisional application No. 61/648,285, filed on May 17, 2012.
(60) Provisional application No. 61/559,847, filed on Nov. 15, 2011.

(51) Int. Cl. G02B 21/00; G02B 27/09; G01N 21/01

(52) U.S. Cl. CPC G02B 21/0084; G01N 21/01; G02B 27/0927; G02B 21/0032
USPC 348/80; 250/208.1; 359/558; 359/618; 359/388

(57) ABSTRACT

A temporal focusing system is disclosed. The temporal focusing system is configured for receiving a light beam pulse and for controlling a temporal profile of the pulse to form an intensity peak at a focal plane. The temporal focusing system has a prismatic optical element configured for receiving the light beam pulse from an input direction parallel to or collinear with the optical axis of the temporal focusing system and diffracting the light beam pulse along the input direction.

### RELATED APPLICATIONS

This application claims the benefit of priority of U.S. Provisional Patent Application No. 61/559,847 filed on Nov. 15, 2011, and 61/648,285 filed on May 17, 2012, the contents of which are incorporated herein by reference in their entirety

### FIELD AND BACKGROUND OF THE INVENTION

The present invention, in some embodiments thereof, relates to optics and, more particularly, but not exclusively, to method and system for transmitting light using on-axis temporal focusing.

Optical sectioning is a technique which allows viewing preselected depths within a three-dimensional structure. Several systems are known to provide optical sectioning, including confocal microscopy and multiphoton microscopy.

The confocal microscope, disclosed in U.S. Pat. No. 3,013,467, utilizes optical sectioning of microscopic samples. This technique is based on the rejection of out-of-focus scattering using a confocal pinhole in front of the detection system. The technique employs point-by-point illumination of a sample and uses mechanical scanning for displacing the light beam and/or the sample so as to collect an image.

Multiphoton microscopes offer a different mechanism for optical sectioning. This technique is based on nonlinear optical phenomena that reduce the need for rejecting out-of-focus scattering. A multiphoton process, most commonly two-photon excitation fluorescence (TPEF), is efficient at the focal spot where the peak intensity of the illuminating light is high.

U.S. Pat. No. 7,698,000 discloses an optical technique known as temporal focusing. A temporal pulse manipulator is configured to affect trajectories of light components of an input pulse impinging thereon so as to direct the light components towards an optical axis of a lens along different optical paths. The temporal pulse manipulator unit is accommodated in a front focal plane of the lens, thereby enabling to restore the input pulse profile at the imaging plane. Temporal focusing allows to simultaneously illuminate a single line or a plane inside a volume of interest while maintaining optical sectioning.

### SUMMARY OF THE INVENTION

According to an aspect of some embodiments of the present invention there is provided an optical system, comprising a temporal focusing system characterized by an optical axis and being configured for receiving a light beam pulse and for controlling a temporal profile of the pulse to form an intensity peak at a focal plane, the temporal focusing system having a prismatic optical element configured for receiving the light beam pulse from an input direction parallel to or collinear with the optical axis and diffracting the light beam pulse along the input direction.

According to some embodiments of the invention the temporal focusing system comprises a collimator and an objective lens aligned collinearly with respect to optical axes thereof, and wherein the prismatic optical element is configured for diffracting the light beam onto the collimator.

According to some embodiments of the invention the objective lens is at a fixed distance from the collimator.

According to some embodiments of the invention the system comprises a spatial manipulating system positioned on the optical path of the light beam pulse and aligned such the spatial manipulating optical system and the temporal focusing system are optically parallel or collinear with respect to optical axes thereof.

According to some embodiments of the invention the spatial manipulating system comprises a spatial focusing system.

According to some embodiments of the invention the spatial focusing system comprises at least one of a cylindrical lens and a spherical lens.

According to some embodiments of the invention the spatial manipulating system comprises an optical patterning system.

According to some embodiments of the invention the optical patterning system comprises at least one of a spatial light modulator (SLM), and a digital light projector.

According to some embodiments of the invention the prismatic optical element is mounted on a stage movable with resects to the optical axis.

According to some embodiments of the invention the system comprises a controller for moving the stage.

According to some embodiments of the invention the system comprises a beam splitting arrangement configured to split the light beam to a plurality of secondary light beams, wherein at least a few of the secondary light beams propagate along an optical path parallel to the input direction, and wherein the temporal focusing system comprises a plurality of prismatic optical elements each arranged to receive one secondary part light beam and to diffract a respective part along a respective optical path.

According to some embodiments of the invention the system comprises a redirecting optical arrangement configured for redirecting the diffracted secondary light beams such that all secondary light beams propagate in the temporal focusing system collinearly with the optical axis thereof.

According to some embodiments of the invention the temporal focusing system is characterized by a numerical aperture of at least 0.5 and optical magnification of at least 40.

According to some embodiments of the invention the system comprises a light source and a light detection system, the optical system being configured for multiphoton microscopy.

According to some embodiments of the invention the light detection system comprises an electron multiplier charge coupled device (EMCCD).

According to some embodiments of the invention the light detection system comprises a charge coupled device line sensor.

According to some embodiments of the invention the system comprises a light source, a light detection system, and a data processor configured to receive light detection data from the light detection system and stage position data from the controller and to provide optical sectioning of a sample, wherein each optical section corresponds to a different depth in the sample.

According to some embodiments of the invention the system is configured for multiphoton manipulation.

According to some embodiments of the invention the system is configured for material processing.

According to some embodiments of the invention the system is configured for photolithography.

According to some embodiments of the invention the system is configured for photoablation.

According to some embodiments of the invention the system is configured for neuron stimulation.

According to some embodiments of the invention the system is configured for three-dimensional optical data storage.

According to an aspect of some embodiments of the present invention there is provided an optical system, comprising: a beam splitting arrangement configured for split an input light beam pulse to a plurality of secondary light beams propagating along a separate optical path; a temporal focusing optical system configured for receiving each of the secondary light beams and for controlling a temporal profile of a respective pulse to form an intensity peak at a separate focal plane.

According to an aspect of some embodiments of the present invention there is provided an optical kit for multiphoton microscopy, comprising a light source, an objective lens, a collimator, a first optical set having at least a prismatic optical element, and a second optical set having at least one lens; each of the first and the second optical sets being interchangeably mountable on a support structure between the light source and the objective lens to allow light beam from the light source to incident on a respective optical set collinearly with an optical axis of the objective lens; wherein when the first optical set is mounted, temporal focusing is effected at a focal plane near the objective, and when the second optical set is mounted, only spatial focusing is effected at the focal plane.

According to some embodiments of the invention the kit further comprising a first light detection system for detecting light from a sample when the first set is mounted, a second light detection system for detecting light from the sample when the second set is mounted, and a rotatable dichroic mirror for selectively directing the light from the sample either to the first light detection system or to the second light detection system.

According to an aspect of some embodiments of the present invention there is provided a system for multiphoton microscopy, comprising: a light source, an objective lens, a collimator, a first optical set having at least a prismatic optical element, a second optical set having at least one lens, and an optical switching system; wherein the first optical set is configured for effecting temporal focusing at a focal plane near the objective, the second optical set is configured for effecting only spatial focusing at the focal plane; and wherein the switching optical system is configured for deflecting an input light beam to establish an optical path either through the first optical set or through the second optical set.

According to an aspect of some embodiments of the present invention there is provided a method of manipulating light, comprising generating a light pulse and using the system described above, for controlling a temporal profile of the pulse to form an intensity peak at a focal plane.

According to some embodiments of the invention the method further comprising using the light for processing a material.

According to some embodiments of the invention the method further comprising using the light for photolithography.

According to some embodiments of the invention the method further comprising using the light for photoablation.

According to some embodiments of the invention the method further comprising using the light for neuron stimulation.

According to some embodiments of the invention the method further comprising using the light for three-dimensional optical data storage.

According to an aspect of some embodiments of the present invention there is provided a method of imaging a sample, comprising: acquiring a first depth image of the sample using multiphoton laser scanning microscopy; acquiring a second depth image of the sample using multiphoton temporal focusing microscopy; using the first depth image to calculate a transfer matrix describing a relation between individual elements of the sample and the first depth image; and processing the second depth image using the transfer matrix.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is an illustration of a conventional temporal focusing setup;

FIG. 2 is a schematic illustration of an optical system, according to some embodiments of the present invention;

FIG. 3 is a schematic illustration of a prismatic element which can be used in the optical system, according to some embodiments of the present invention;

FIG. 4 is a schematic illustration of an embodiment of the invention according to which the focal plane is controlled by the position of the prismatic element;

FIG. 5 is a schematic illustration of an optical system in embodiments of the invention in which a plurality of optical paths are employed;

FIG. 6 is a schematic illustration of an optical kit for multiphoton microscopy, according to some embodiments of the present invention;

FIG. 7 shows a two-dimensional structure of neural cells used in experiments performed according to some embodiments of the present invention.

FIG. 8 shows calcium transients in the cells of FIG. 7, resulting from neuronal activity.

FIG. 9 shows three-dimensional structure of neural cells in vitro used in experiments performed according to some embodiments of the present invention

FIG. 10 are images of the transparent hydrogel for used in experiments performed according to some embodiments of the present invention.

FIGS. 11A-C show experimental results obtained in experiments performed according to some embodiments of the present invention to study the relation between the movement of the prismatic element and the location of the focal plane.

FIGS. 12A-D illustrate an outline of an experimental procedure used according to some embodiments of the present invention.

FIGS. 13A-D show light propagation as obtained in computer simulations performed according to some embodiments of the present invention.

FIGS. 14A-C show measured axial optical sectioning and theoretical prediction (lines) for three sets of optical parameters, as obtained in a study conducted according to some embodiments of the present invention.

FIG. 15 shows comparison of calculated axial optical sectioning for different beam waists (dots) and best-fit products of two square roots of Lorentz-Cauchy functions (lines), as obtained in a study conducted according to some embodiments of the present invention.

FIGS. 16A-B show comparison of line temporal focusing calculated optical sectioning and analytical approximation, as obtained in a study conducted according to some embodiments of the present invention.

FIGS. 17A-B show scattering effects as obtained in a study conducted according to some embodiments of the present invention.

FIG. 18 shows an example of deep penetration into a scattering phantom as obtained in a study conducted according to some embodiments of the present invention.

FIG. 19A is a schematic illustration of an imaging setup used in a study directed according to some embodiments of the present invention to neural activity extraction.

FIG. 19B shows comparison of a beam spread function (BSF) model predictions for light radial distribution with Monte-Carlo simulations for different scattering depths, as obtained in a study conducted according to some embodiments of the present invention.

FIG. 20 shows simulation results for blurred images at different scattering depths, as obtained in a study conducted according to some embodiments of the present invention.

FIG. 21 shows reconstruction of cells simulated activity patterns with different noise levels, as obtained in a study conducted according to some embodiments of the present invention.

FIG. 22 is a schematic illustration of an optical system in embodiments of the present invention in which the system is optically coupled to an endoscope.

FIG. 23 is a schematic illustration of an optical system having a switching system, according to some embodiments of the present invention.

FIGS. 24A and 24B show experimental results using a patterned light beam, according to some embodiments of the present invention.

### DESCRIPTION OF SPECIFIC EMBODIMENTS OF THE INVENTION

The present invention, in some embodiments thereof, relates to optics and, more particularly, but not exclusively, to method and system for transmitting light using on-axis temporal focusing.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

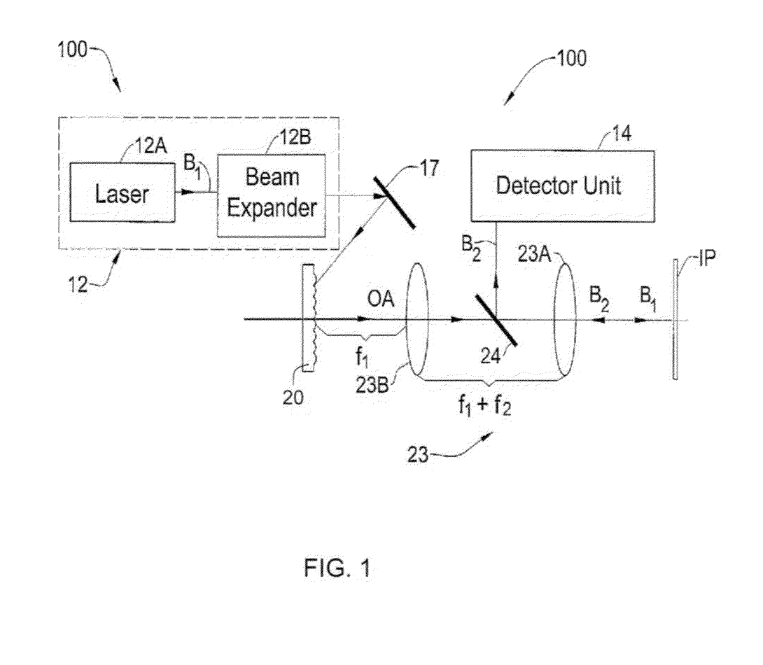

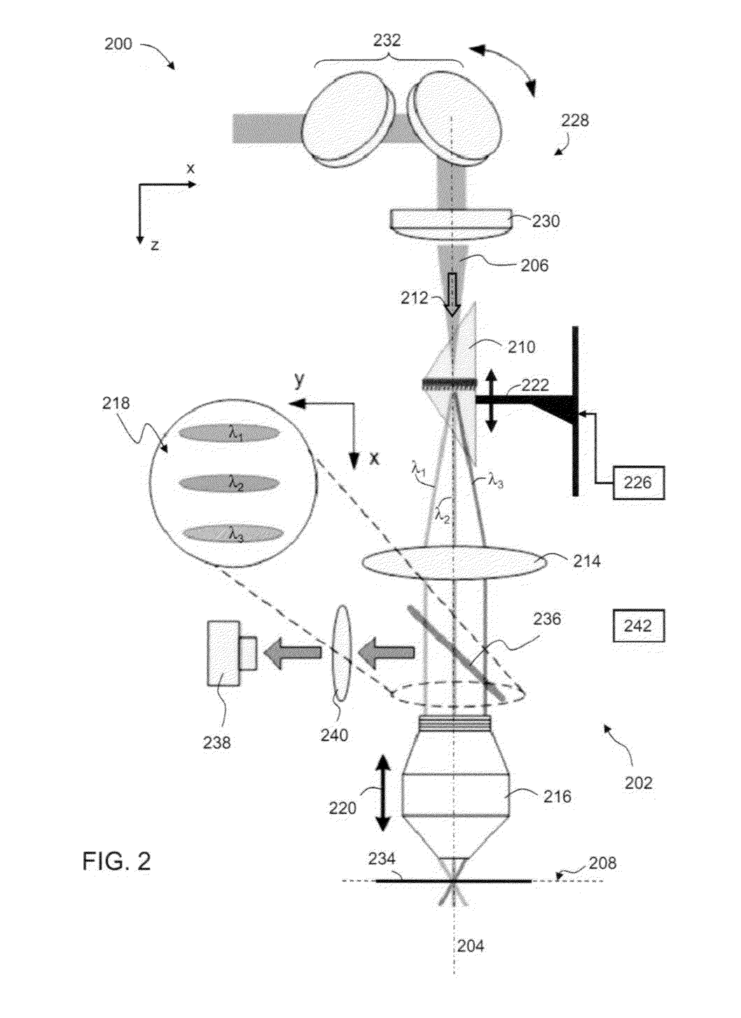

For purposes of better understanding some embodiments of the present invention, as illustrated in FIGS. 2-10 of the drawings, reference is first made to the construction and operation of a conventional temporal focusing setup as illustrated in FIG. 1.

FIG. 1 shows schematically a microscope setup 100 for fluorescence imaging having a light source assembly 12 including a laser oscillator 12A generating laser pulses B₁ at a repetition and a beam expander 12B operating to spatially expand the input pulse to a Gaussian shape. The expanded pulse is directed onto a reflective diffraction grating 20, via a mirror 17, oriented so as to direct the laser pulse B₁ onto diffraction grating 20 at a certain non-zero angle of incidence such that the central wavelength of the pulse is diffracted towards the optical axis OA of microscope 100. Diffraction grating 20 is arranged perpendicular to the optical axis OA.

An optical system further includes a lens arrangement 23 and a dichroic mirror 24. Lens arrangement 23 includes an achromatic lens 23B and an objective lens 23A. Lenses 23A and 23B have focal length f₂ and f₁, respectively, and are spaced from each other at a distance (f₁+f₂). Lens 23B is positioned at a distance f₁ from diffraction grating 20, so that grating 20 is imaged at an imaging plane IP which is the focal plane of objective 23A. Dichroic mirror 24 is accommodated between lenses 23A and 23B to direct the fluorescence laser from the sample into a detector unit 14.

Once pulse B₁ propagates between grating 20 and the imaging plane IP, the pulse duration is longer than its initial due to the difference in the optical path lengths taken by the light rays diffracted from different locations on grating 20. Only at the image plane IP the pulse duration restores its initial value, based on the Fermat principle according to which the path of a light ray from one point to its image will be that taking the least time. Thus, points outside the focal plane IP undergo extended illumination. This process is known as temporal focusing.

The temporal focusing techniques can be utilized to simultaneously illuminate a single line or a plane inside a volume of interest, while maintaining optical sectioning by manipulating the laser pulse duration. However, it was found by the present Inventors that when this technique is applied to optical imaging inside a thick biological sample, the effectiveness of optical processes such as imaging and light-tissue interactions is reduced since tissue scattering effects change the illuminating light distribution, attenuate its power and scatter the emitted light.

The present inventors also found that it is difficult to integrate the conventional temporal focusing setup into an existing laser-scanning multiphoton imaging systems, since in conventional temporal focusing setup light must propagates off-axis between mirror 17 and grating 20.

In a search for an improved temporal focusing technique, the present inventors found that the efficiency and simplicity of the optical system can be significantly improved by employing on-axis temporal focusing.

Reference is now made to FIG. 2 which is a schematic illustration of an optical system 200, according to some embodiments of the present invention.

FIG. 2 shows system components suitable for utilizing system 200 in imaging (e.g., multiphoton microscopy), but is should be understood that the principles and operations of the system 200 are applicable also to other applications, including, without limitation, multiphoton manipulation, material processing (e.g., photolithography), in-vivo and ex-vivo tissue treatment (e.g., photoablation, gluing, bond breaking, neuron stimulation), optical data storage (e.g., three-dimensional optical data storage via multiphoton absorption), and the like.

System 200 comprises a temporal focusing system 202, characterized by an optical axis 204, and being configured for receiving a light beam 206. In the schematic illustration shown in FIG. 2, optical axis 204 is along the z direction, which is also referred to herein as the axial direction. The x- and y-directions which are orthogonal to the z direction are referred to collectively as the lateral directions.

Light beam 206 is in the form of a pulse or a pulse sequence or a plurality of pulse sequences. In various exemplary embodiments of the invention the pulse sequence is defined by two or more pulses having one or more identical characteristics, wherein the identical characteristic is/are selected from the group consisting of identical spectrum, identical duration and identical intensity. The pulse is preferably sufficiently short to generate nonlinear optical effects once light beam 206 interacts with a sample medium (not shown). A typical pulse width is, without limitation from a few hundreds of attoseconds to a few picoseconds. Typical single pulse energy is, without limitation, from about 10 nJ to a few (e.g., 10) mJ. Typical spectrum of light beam 206 is, without limitation in the red and near infrared spectral range (e.g., from about 600 nm to about 2.5 μm). Other characteristics for light beam 206 are not excluded from the scope of the present invention.

Temporal focusing system 202 controls the temporal profile of light beam pulse 206 to form an intensity peak at a focal plane 208, by virtue of the Fermat principle as further detailed hereinabove. Temporal focusing system 202 comprises a prismatic optical element 210 which receives light beam 206 from an input direction 12 parallel to or collinear with optical axis 204 and diffracts light beam 206 along input direction 12. This is unlike the setup 100 shown in FIG. 1, in which grating 20 receives the light B₁ from mirror 17 at a direction which is at an angle to the OA direction. Thus, light beam 206 continues according to the present embodiment continues on-axis through prismatic element 210, wherein the propagation direction of light beam 206 before and after the passage through prismatic element 210 is parallel or, more preferably collinear with optical axis 208 of temporal focusing system 202.

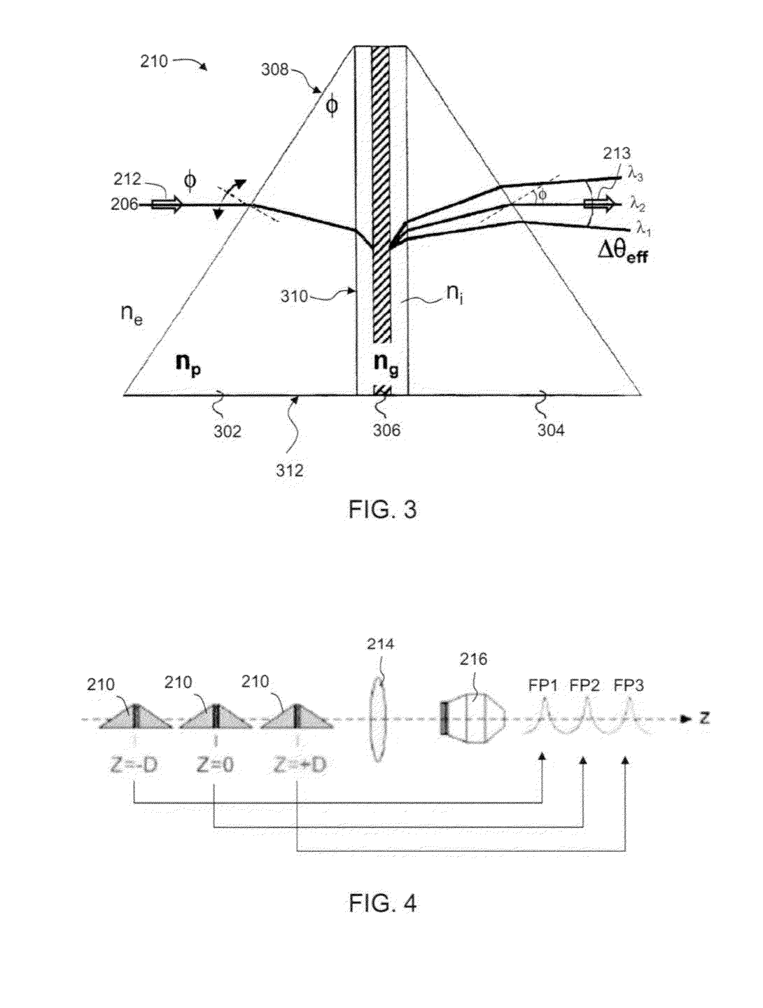

Prismatic element 210 can be a dual prism grating element, also known in the art as a “grism” element. A schematic illustration of prismatic element 210 suitable for some embodiments of the present invention is schematically illustrated in FIG. 3. In these embodiments, prismatic element 210 comprises two prisms 302 and 304 and a transmissive diffraction grating 306. In accordance with an embodiment of the invention, prism 302 is made of a material characterized by a refractive index nₚ and includes an angled surface 308 defined by an angle φ measured between surface 308 and a normal 310 to a base 312 of prism 302. Diffraction grating 306 is made of a material characterized by a refractive index n_{g}. Grating 306 can be, for example, a holographic grating.

The medium adjacent to element 210 can be air or any other material having a different refractive index nₑ, which is different, preferably lower, than, nₚ. For example, when system 202 operates in open air, the external medium is air and nₑ=1. In some embodiments of the present invention diffraction grating 306 is separated from prisms 302 and 304 by a material having a refractive index nᵢ other than nₚ.

In operation, light beam 206 is incident on surface 308 of prism 302, for example, at an angle φ with respect to the normal surface 308 and is refracted into prism 302 at an angle set by Snell's law. Beam propagates in prism 302 to incident on grating 306. When grating 306 is separated from prisms 302 and 304 by a material nᵢ, beam 206 experiences another refraction event at the interface between nₚ and nᵢ, before arriving to grating 306. At grating 306 light beam 206 is diffracted according to the characteristic diffraction equation of grating 306, and according to the wavelength of the light. Thus, light rays of different wavelengths constituted in beam 206 are typically diffracted at different angles. In the schematic illustration of FIG. 3, three light rays, having wavelengths λ₁, λ₂ and λ₃, are illustrated, representing the highest, central and lowest wavelengths in beam 206, respectively. Each light ray propagates in prism 304 and is refracted out into the external medium nₑ.

In various exemplary embodiments of the invention prismatic element 201 is symmetrical in that prism 304 is also be made of a material characterized by the same refractive index nₚ and also includes an angled surface defined by the same angle φ. This allows the beam in and out of the grating 306 to be at the same angle (Littrow's angle) thus improving the efficiency of element 210 for any polarization.

The characteristics of element 210 (nₚ, n_{g}, φ) are selected according to the needs of the temporal focusing system 202. In various exemplary embodiments of the invention the characteristics of element 210 are selected such that for light rays having the central wavelength λ₂, the exit direction 213 is parallel or, more preferably collinear, with the entry direction 212 of beam 206.

Different choices of the prism material (e.g., glass, silicon or other high refractive index materials) and prism angle φ allow to a large extent customization of the output beam spread denoted Δθ_{eff} to match the requirements of system 202. The advantage of prismatic element 212 is the ability to achieve high spectral dispersion while maintaining forward beam propagation.

Referring now again to FIG. 2, temporal focusing system 202 optionally and preferably comprises a collimator 214 and an objective lens 216 aligned collinearly with respect to their optical axes. In these embodiments, prismatic optical element 210 is positioned so as to diffract the light beam onto collimator 214. Collimator 214 serves for redirecting at least some of the light rays exiting prismatic element 210 such that all the light rays exit collimator 214 parallel to each other. Collimator 214 can be, for example, a tube lens or the like. The objective 216 receives the parallel light rays and redirects them on image plane 208. A cross-sectional view of the back aperture of objective 216 in the x-y plane is illustrated at 218.

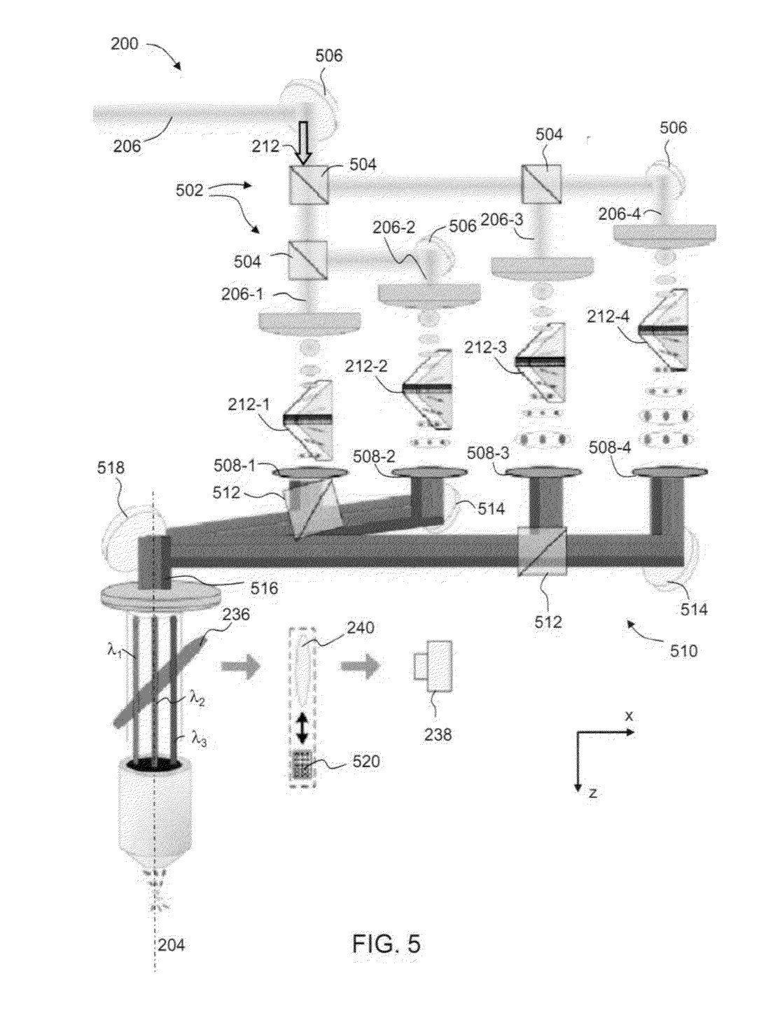

Collimator 214 and objective 216 can be arranged as a telescope system. In various exemplary embodiments of the invention the distance between collimator 214 and objective 216 equals the sum of their focal lengths. The distance between the center of prismatic element 210 and collimator 214 can equal the focal length of collimator 214, and the distance between objective 216 and the focal plane 208 can, in some embodiments of the present invention equal the focal length of objective 216. Objective 216 can be allowed for reciprocal motion 220 along the z direction, so as to allow optical sectioning in different sample planes. However, this need not necessarily be the case, since the present Inventors discovered a technique for providing scanning of the optical sectioning plane without moving the objective. Thus, in some embodiments of the present invention objective lens 216 is at a fixed distance from collimator 214. The present inventors found that the location of focal plane 208 can be controlled by the position of prismatic element 210 along the axial direction. The concept is schematically illustrated in FIG. 4. Shown in FIG. 4 are several positions of prismatic element 210 along the axial direction (the z direction in the present example). In the schematic illustration of FIG. 4, three equally-spaced positions of element 210 are shown, at z=−D, z=0 and z=+D, where D is an arbitrary number. It is to be understood that other positions are not excluded from the scope of the present invention. For each position, an intensity peak of the pulse is formed at a different distance from objective 216. The peaks are designated FP1, FP2 and FP3, corresponding to locations z=−D, z=0 and z=+D, respectively.

Thus, optical sectioning is achieved according to some embodiments of the present invention by varying the position of prismatic element 210 while maintaining a fixed position of objective 216 and, optionally also of collimator 214. This can be done using a movable stage 222 on which prismatic optical element 210 is mounted. Stage 222 is operative to move 224, preferably reciprocally, along the axial axis. The motion of stage 222 can be controlled by a controller 226. Optionally and preferably a data processor 242 communicates with controller 226 and provides timing for its operation.

In some embodiments of the present invention system 200 comprises a spatial manipulating optical system 228, positioned on the optical path of light beam 206 and aligned such spatial manipulating optical system 228 and temporal focusing system 202 are optically parallel or collinear with respect to their optical axes. Spatial manipulating optical system 228 preferably comprises at least one optical system 230 having a static optical axis for performing the spatial manipulation.

In some embodiments of the present invention optical system 230 comprises a spatial focusing system. These embodiments are useful when it is desired to utilize both temporal focusing of the illumination pulse and spatial focusing of this pulse along a lateral direction (e.g., the x and/or y axis). Thus, in the present embodiments, system 202 provides the temporal focusing while system 230 provides the spatial focusing along one or both lateral dimensions.

When it is desired to have spatial focusing only along one of the lateral dimension, static optical system can include an anamorphic lens arrangement, such as, but not limited to, a cylindrical lens.

While FIG. 2 illustrates an embodiment in which system 230 is before collimator 214 in terms of the light path, this need not necessarily be the same since, in some embodiments of the present invention system 230 can be interchanged with collimator 214. These embodiments are particularly useful when system 230 is a cylindrical lens.

In some embodiments of the present invention system 228 is also configured for laterally displacing the input light beam 206 along one of the lateral dimensions while directing the beam onto prismatic element 210 through optical system 230. When system 230 is a cylindrical lens, for example, a line image is produced. System 228 can comprise a dynamic optical system 232, such as, but not limited to, an arrangement of scanning mirrors for establishing the lateral displacement of beam 206. In embodiments of the invention in which the location of the focal plane along the axial direction is controlled by varying the position of prismatic element 210, the displacement of prismatic element optionally and preferably is accompanied by a displacement of optical 230 optionally and preferably without changing the direction of its optical axis. Preferably, the distance between prismatic element 210 and system 230 along the axial direction is fixed at all times. This can be achieved by mounting both prismatic element 210 and system 230 on a rigid support structure (not shown) connected to stage 222.

Also contemplated, are embodiments in which the temporal focusing is employed to excite a two-dimensional pattern. In these embodiments, system 230 optionally and preferably comprises an optical patterning system, such as, but not limited to, a spatial light modulator (SLM), and a digital light projector which generates the pattern. The optical patterning system can be position to illuminate the pattern on prismatic element 210. The temporal focusing system images this pattern onto the focal plane 208, while maintaining optical sectioning and high quality illumination.

In various exemplary embodiments of the invention the optical patterning system is transmissive, in which case the light preferably continues on axis while passing through the optical patterning system. In some embodiments, the optical patterning system is made reflective, in which case the light is redirected before it arrives at element 210. Also contemplated, are embodiments in which the optical patterning system is reflective but is positioned such that the deflection of the light beam due to the interaction with the optical patterning system is small (e.g., less than 10 degrees, or less than 5 degrees, or less than 3 degrees, or less than 2 degrees). For example, an SLM can be positioned such that its reflective plane is at a small angle (e.g., less than 10 degrees, or less than 5 degrees, or less than 3 degrees, or less than 2 degrees) to axis 204.

Further contemplated, are embodiments in which the temporal focusing is employed in a wide-field illumination, in which case a cylindrical lens is not required. In these embodiments, lens arrangement 230 optionally and preferably comprises a spherical lens.

In some embodiments of the invention, a large magnification telescope (for example, magnification of at least 40× or at least ×50 or at least ×60 or at least ×100 or at least ×200 or at least ×300 or at least ×400, preferably, but not necessarily up to ×500) and a high numerical aperture objective (for example, NA of at least 0.5 or at least 0.75, e.g., 1) is incorporated in system 200. These embodiments allow illuminating a small shape (e.g., short line), which is relatively robust to tissue scattering. The advantage of this embodiment is that it provides both spatial and temporal focusing which can be useful in many applications, including, without limitation, single cell manipulation in deep tissue, and depth imaging of biological material with reduced or eliminated out-of-focus excitation. The out-of-focus excitation is reduced or eliminated since the temporal focusing effect reduces or prevents effective two-photon excitation near the tissue surface. A representative example of these embodiments is provided in the Example 4 of the Examples section that follows.

As stated, system 200 can be used for various applications. When system 200 is used for material processing or treatment, the material (not shown) to be processed or treated is placed at the focal plane 208 or the focal plane 208 is brought to be engaged by the material. The peak intensity at focal plane 208 is used for optically processing or treating the material. Preferably, but not necessarily, the light characteristics are selected to cause non-linear optical interaction between the material and the light. For example, the light characteristics can be selected to effect two-photon absorption by the material.

A representative example of material processing according to some embodiments of the present invention is patterning, e.g., photolithography patterning. In these embodiments, a relative motion in the lateral dimension is established between the material and the temporal focus peak of the light such that the temporal focus peak patterns the material according to the desired shape. The relative motion in the lateral dimension can be achieved by moving the material (e.g., using a movable stage 234 configured to move in a plane defined by the two lateral directions), or it can be achieved by scanning the input light beam (e.g., by means of scanning mirrors 232).

The patterning can be one-dimensional, two-dimensional, or three-dimensional. Any patterning along a lateral direction can be effected by scanning the input light beam or moving the material along that direction, and any patterning along the axial direction can be effected by moving the objective 216 and/or prismatic element 210 along the axial direction.

Another representative example of material processing according to some embodiments of the present invention is optical data storage. In these embodiments, the material is an optical storage medium, and a relative motion in the lateral dimension is established between the optical storage medium and the temporal focus peak of the light such that the temporal focus peak encodes optical data onto the memory medium. The relative motion in the lateral dimension can be achieved by moving the memory medium, and/or scanning the input light beam. For example, the memory medium can be rotated in the lateral plane and the input light be can be scanned along one of the lateral directions, thus effecting data encoding in circular tracks. The data encoding can be also be three-dimensional, in which case the light peak is also shifted along the axial direction (by moving the objective 216 and/or prismatic element 210 along the axial direction) to encode the optical data also into the bulk.

Three-dimensional data storage is advantageous from the standpoint of data storage density. Writing with three-dimensional resolution is optionally and preferably accomplished by non-linear excitation of the medium to confine data storage to the selected focal plane. Consider, for example, a single focused Gaussian beam, well below saturating intensity, incident on a physically thick but optically thin absorbing medium. For the case of excitation that is linear in the direction of the incident radiation, the same amount of energy is absorbed in each plane transverse to the optical axis regardless of distance from the focal plane, since nearly the same net photon flux crosses each plane. Thus, linear excitation strongly contaminates planes above and below the particular focal plane being addressed. On the other hand, for an excitation scheme with quadratic dependence on the intensity, the net excitation per plane falls off with the inverse of the square of the distance from the focal plane. Thus, information can be written in a particular focal plane without significantly contaminating adjacent planes beyond the Rayleigh range. The minimum spot size for data storage can be approximated by the Rayleigh criterion for a round aperture.

A representative example of material treatment is photoablation of biological material (e.g., tissue). The photoablation can be done in vivo or ex vivo. In these embodiments, the light characteristics are selected to damage the biological material, preferable to destroy it. A relative motion in the lateral dimension is optionally established between the biological material and the temporal focus peak as further detailed hereinabove. When the photoablation is performed in vivo, the relative motion in the lateral dimension is preferably achieved by scanning the input light beam without moving the biological material. When photoablation is performed in vivo, the relative motion in the lateral dimension can be achieved by scanning the input light and/or moving the biological material. The photoablation can be zero-dimensional (at a point), one-dimensional, two-dimensional, or three-dimensional. Any photoablation along a lateral direction can be effected by scanning the input light beam or moving the biological material along that direction, and any photoablation along the axial direction can be effected by moving the objective 216 and/or prismatic element 210 along the axial direction to cause photoablation at the desired depth of the biological material.

Another example of material treatment is the stimulation of a sample comprising biological neurons. The stimulation can be done in vivo or ex vivo, as further detailed hereinabove with resects to photoablation, except that the light characteristics are selected to stimulate the neurons in the sample, optionally and preferably without damaging them. The biological neurons can be placed in a chamber containing a biological neural network, and can be used as a “brain in chip” neural interface.

System 200 can also be employed for imaging. For example, objective lens 216 can be used as a second lens, so that light returning from the imaged sample (e.g., fluorescence light) passes through lens 216 in the opposite direction to effect epi-detection. The light from the sample can be redirected, for example, by a dichroic mirror 236, into a light detection system 238, optionally and preferably via a concentrating lens a lenslet array 240.

Detection system 238 can comprise, for example, a photomultiplier tube (PMT) and a charge coupled device (CCD), or an electron multiplier CCD (EMCCD) or a CCD line sensor. The present inventors found that CCD line sensor is particularly useful when scanning-line imaging is employed, since the CCD line sensor can reduce the scattering effect. Spatial scanning along the lateral direction(s) is optionally and preferably performed using system 228 as further detailed hereinabove. The operation of detection system 238 is optionally and preferably synchronized with the lateral scan. The synchronization can be accomplished by data processor 242 which can be a general computer or dedicated circuitry.

When it is desired to effect optical sectioning, the location of the focal plane can be controlled by moving the objective lens 216 or, more preferably, prismatic element 210, along the axial direction. In these embodiments, the operation of detection system 238 is preferably also synchronized with the displacement along the axial direction of the respective component (objective lens and/or prismatic element).

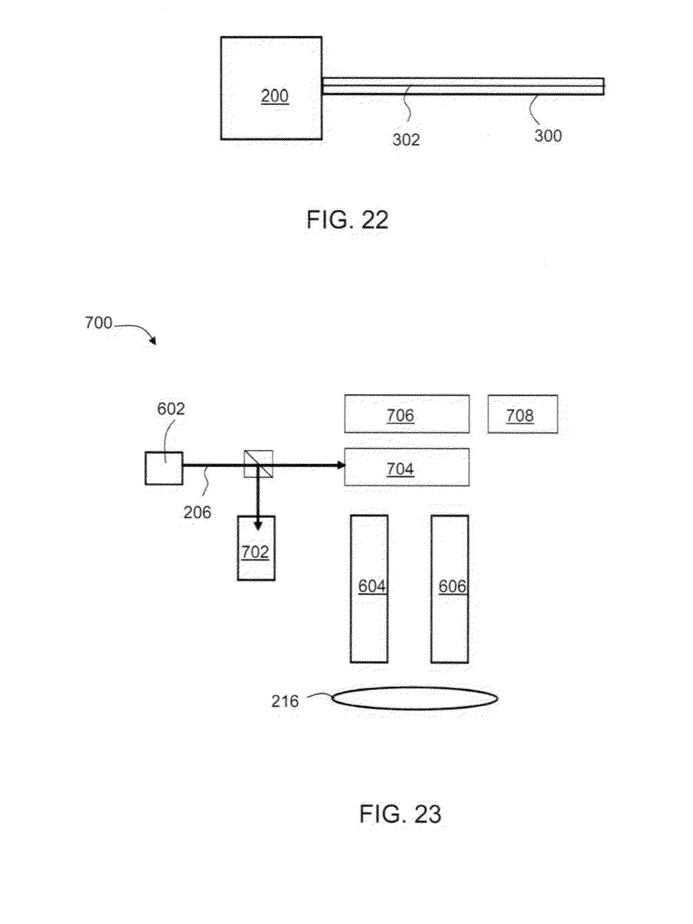

System 200 can also be coupled to an endoscope. This embodiment is illustrated in FIG. 22, showing system 200 optically coupled to an endoscope 300, wherein the light from system 200 is guided using an optical fiber 302 along the endoscope. These embodiments are useful for in vivo imaging or in vivo tissue treatment or stimulation.

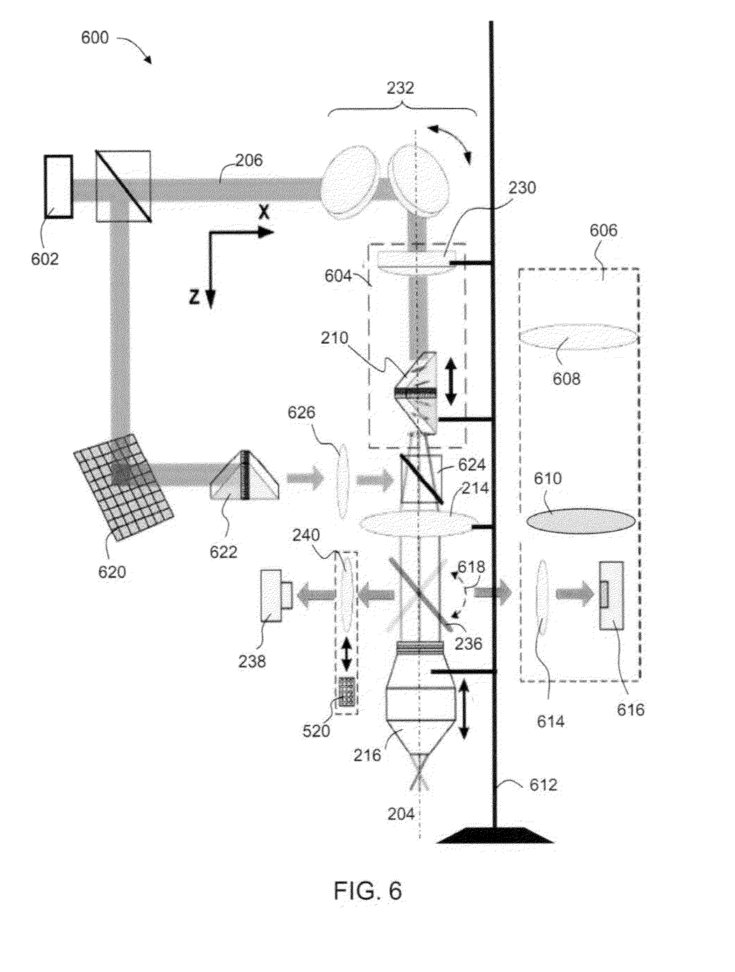

Reference is now made to FIG. 5 which is a schematic illustration of system 200 in embodiments of the invention in which a plurality of optical paths are employed. This configuration is useful, for example, for optical sectioning wherein each optical path corresponds to a different focal plane within the imaged volume.

Reference signs in FIG. 5 which are the same as in FIG. 2, indicate similar components.

In the present embodiments, system 200 comprises a beam splitting and redirection arrangement 502 configured to split light beam 206 to a plurality of secondary light beams, wherein at least a few of the secondary beams propagate along an optical path parallel to input direction 212. Thus, in the present embodiment, system 200 is a multi-arm optical system, each arm corresponding to a separate optical path of a separate secondary light beam.

FIG. 5 illustrates four secondary light beams 206-1, 206-2, 206-3 and 206-4 propagating parallel to direction 212, but it is to be understood that any number of secondary light beams can be employed depending on the arrangement 502. Arrangement 502 can include one or more beam splitters 504 and mirrors 506 as known in the art.

According to some embodiments of the present invention the temporal focusing system comprises a plurality of prismatic optical elements each arranged to receive one of the secondary part light beams and to diffract it along the respective optical path. In the representative illustration of FIG. 5, which is not to be considered as limiting, four prismatic elements 212-1, 212-2, 212-3 and 212-4 are illustrated for diffracting beams 206-1, 206-2, 206-3 and 206-4, respectively.

However, this needs not necessarily be the case, since in some embodiments, not all the optical paths include a prismatic element. For example, in some embodiments, a single prismatic element is employed wherein all secondary light beams are redirected to the prismatic element. Also contemplated, are embodiments in which a single prismatic element is positioned before the splitting into the secondary light beams. Thus, while the embodiments below are described with a particular emphasis to a multi-arm system having a prismatic element in each optical arm, it is to be understood that more detailed reference to such configuration is not to be interpreted as limiting the scope of the invention in any way.

System 200 preferably comprises redirecting optical arrangement 510 configured for redirecting the diffracted secondary light beams and recombining them such that all the diffracted secondary light beams propagate in the temporal focusing system collinearly with respect to optical axis 204. Optical arrangement 510 can recombine the secondary light beams in a planar or non-planar manner. When a planar recombination is employed all the diffracted secondary light beams engage the same plane (for example, the x-z plane), and when a non-planar recombination is employed at least two of the diffracted secondary light beams engage different planes.

In some embodiments of the present invention system 200 comprises a plurality of polarizer elements positioned for polarizing the diffracted secondary light beams before their recombination. In the representative illustration of FIG. 5 four polarizer elements 508-1, 508-2, 508-3 and 508-4 are illustrated for diffracting beams 206-1, 206-2, 206-3 and 206-4. The advantage of polarizing the diffracted light beams is that it facilitates recombining the secondary light beams. Thus, redirecting optical arrangement 510 can comprise one or more polarized beam splitters 512 and mirrors 514, arranged to first recombine the diffracted secondary light beams in pairs (beam 206-1 with beam 206-2 beam 206-3 with beam 206-4, in the present example), and then to recombine all the pairs to a single recombined beam 516. Temporal focusing is then continued for beam 516 as further detailed hereinabove.

It is to be understood, however, that since, for some applications, it may not be necessary for the secondary light beams to be polarized. In these embodiments, the recombination of unpolarized secondary light beam is achieved by optical means as known in the art. For example, non-planar recombination, spectral recombination, coherent recombination and/or use of parabolic mirrors as known in the art.

The recombined beam 516 can optionally and preferably be diverted to effect lateral scanning, for example, using a scanning mirror 518.

The multi-arm configuration of system 200 can be employed to any of the applications described above with respect to the configuration in which a single prismatic element is employed. The advantage of the configuration in FIG. 5 is that it allows imaging, processing, treatment or data encoding at different lateral planes either simultaneously or by switching between different lateral planes using non-mechanical elements, such as, but not limited to, electro-optical elements, as further detailed hereinbelow. Multi-plane temporally-focused diffractive patterns can be generated by splitting the 3D light distribution from a single spatial light modulator (SLM) or using a separate SLM for each optical arm of system 200.

Simultaneous imaging of multiple illuminated planes can be performed using several different imaging methods, which include a light field microscope as described, for example, in ACM Transactions on Graphics 25(3), Proceedings of SIGGRAPH 2006, using a lenslet array 520 which can be positioned between the dichroic mirror 236 and light detection system 238. In these embodiments, the depth resolved images can be obtained from a single snapshot of system 200.

Alternatively, the emitted light can be imaged using a multifocal-plane microscope (MUM) as described, for example in Prabhat, et al. IEEE Trans. Nanobioscience. 3:237-242, where the emitted light is split using one or more beam-splitters and imaged using multiple tube lenses onto multiple imaging cameras.

Still alternatively, using an additional objective lens and a mirror, as disclosed, for example, in Anselmi et al., PNAS 108:19504 (2011), rapid sequential detection of planes can be achieved.

Also contemplated are embodiments in which the planes are illuminated in multiplexed (binary or analog) patterns in rapid succession and the detection of each plane is performed by analyzing the returned patterns.

One of the advantageous of the on-axis temporal focusing of the present embodiments is the ability to assemble different microscopy modalities using similar optical setup. Thus, according to some embodiments of the present invention there is provided an optical kit 600 for multiphoton microscopy.

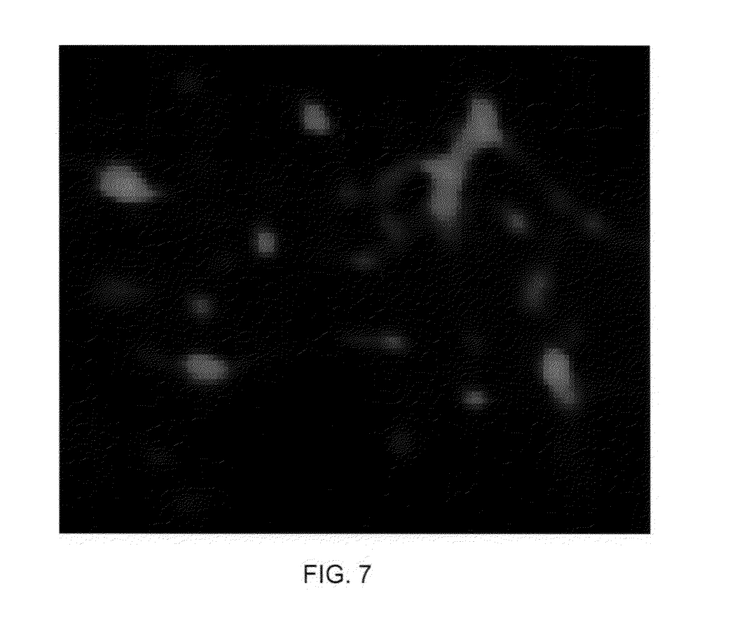

FIG. 6 is a schematic illustration of kit 600 according to some embodiments of the present invention. Reference signs in FIG. 6 which are the same as in FIGS. 2 and/or 5, indicate similar components.

Kit 600 comprises a light source 602, objective lens 216, a first optical set 604 and a second optical set 606. First optical set 604 comprise prismatic optical element 210 and optionally, but not necessarily, also collimator 214 and/or anamorphic lens arrangement 230. Second optical set 606 comprise one or more lenses 608, 610. Each of first 604 and second 606 optical sets is interchangeably mountable on a support structure 612 between light source 602 and objective lens 216 to allow light beam 206 from light source 602 to incident on the respective optical set collinearly with the optical axis of objective lens 216.

The first set 604 is selected to provide temporal focusing. Thus, when first optical set 604 is mounted, temporal focusing is effected, optionally and preferably in combination with lateral spatial focusing, as further detailed hereinabove with respect to system 200.

The second set is selected to provide spatial focusing, optionally and preferably, by means of multiphoton laser scanning microscopy, as described, e.g., in U.S. Pat. No. 6,094,300. For example, lens 608 can serve as a scan lens and lens 610 can serve as a converging lens before the objective 216. In some embodiments of the present invention lens 610 is the same as collimator 214, so it is not necessary to interchange collimator 214 and lens 610. In these embodiments, collimator 214 preferably remains mounted both the temporal focusing microscopy and for the laser scanning microscopy, so that none of collimator 214 and lens 610 is included in the interchangeable optical sets 604 and 606.

When first set 604 is mounted on structure 612, the light detection is optionally and preferably by means of dichroic mirror 236 and detection system 238 as further detailed hereinabove. Optionally, lens 240 or lenslet 520 is position on the optical path between the dichroic mirror 236 and the detection system 238 as further detailed hereinabove.

When second set 606 is mounted on structure 612, the light detection is optionally and preferably by means of dichroic mirror 236 and a detection system 616, which can include, for example, a photomultiplier tube (PMT). Optionally, a lens 614 is position on the optical path between the dichroic mirror 236 and the detection system 616.

Thus, the present embodiments provide an optical setup that combines an improved temporal focusing microscope with a multi-photon laser scanning microscope. The switching from temporal focusing to laser scanning is by replacing set 604 with set 606, and the switching from laser scanning to temporal focusing is by replacing set 606 with set 604.

The light detection components can be included in the respective optical sets so that when it is desired to switch between microscopy techniques, the respective light detection components are replaced. Alternatively, the light detection components of both microscopy techniques can be co-mounted, for example, at opposite lateral sides of the optical axis 204. In these embodiments, the dichroic mirror 236 is preferably mounted on a rotatable structure (conceptually represented by an arrow 618), so that when set 604 is mounted, dichroic mirror 236 assumes an orientation for directing the light from the sample toward detection system 238, and when set 606 is mounted, dichroic mirror 236 assumes an orientation for directing the light from the sample toward detection system 616.

In various exemplary embodiments of the invention the optical kit also includes an embodiment of temporal focusing stimulation system. Light beam 206 can be split and directed towards an SLM 620, which form a phase pattern. Using a prismatic element 622, which may be similar to element 210, the light can continues to collimator 214. When the optical path from SLM 620 is not parallel to the optical path of collimator 214 (for example, when the optical path is perpendicular to the optical axis of collimator 214), a dichroic mirror 624 can be used for redirecting the light onto collimator 614. Optionally, a converging lens 626 is positioned on the light path between element 622 and mirror 624. In some embodiments of the present invention the pattern is axially scanned by moving the objective lens, or by moving prismatic element 210 as further detailed hereinabove.

The advantage of kit 600 is that it allows combining information from laser scan microscopy which provides relatively unscattered images, with temporal focusing microscopy which provides simultaneous illumination of a line or a plane. Kit 600 can be used in some embodiments of the present invention for single-cell stimulation inside a scattering biological medium.

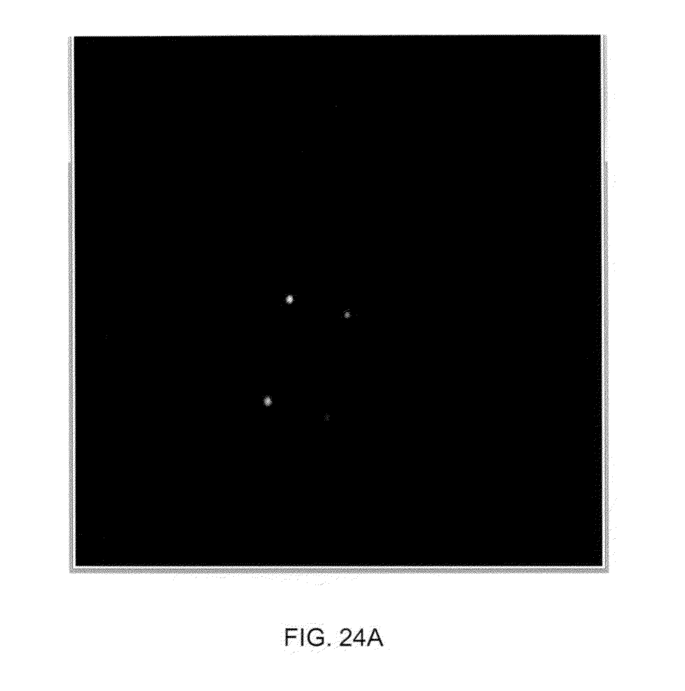

An optical system similar to kit 600 can also be employed without having to un-mount and remount the various components on structure 612. This embodiment is schematically illustrated in a block diagram of FIG. 23. Shown in FIG. 23 is an optical system 700 which comprises light source 602, objective lens 216, first optical set 604 and second optical set 606, as further detailed hereinabove. Optionally, system 700 also comprises a third optical set 702 for generating a patterned light beam. For example, set 702 can comprises SLM 620, prismatic element 622 and optionally also lens 626 as further detailed hereinabove. System 700 also comprises an optical switching system 704 and a controller 706 for selecting an optical set from sets 604 and 606 and optionally also set 702, and for directing the light beam 206 to the selected set. Switching system 704 can comprises an arrangement of mirrors as known in the art. Optionally, system 700 also comprises a user interface 708 for allowing the operator to select the desired optical set.

It was found by the present inventors that images or volumetric images acquired by the camera in conventional temporal focusing technique tend to be blurry deep in the imaged material, and quickly deteriorate to a point that individual features (e.g., cells) cannot be resolved. The present inventors devised a technique which allows distinguishing between individual features in the temporal focusing image, using information extracted from the laser scan microscopy.

According to some embodiments of the present invention the laser scan microscopy image is used for calculating a transfer matrix describing a relation between individual elements (e.g., cells, neurons) of the sample the image. This matrix provides the location of the individual elements inside the imaged volume. The matrix is thereafter used for possessing the temporal focusing image.

Mathematically, the procedure can be described as follows: let V be a vector of the data as measured by the laser scan microscopy, and let A be a vector describing the detectable interaction of an individual element in the sample with the light. For example, when the sample contains neurons A can include be the activation amplitudes of the neurons. Let S be a transfer matrix describing the relation between V and A, e.g., V=S·A+n, where n is a noise vector. The matrix S can be viewed as a point spread function matrix which describes the response of the microscope to the individual elements in the sample. For example, when the sample contains neurons, the matrix S describes the response of the microscope to the activation of neurons.

The equation V=S·A+n can be solved by inverting the matrix S. This can be done using image deconvolution technique, pseudoinverse technique, and/or various regularization procedures including, without limitation, singular value decomposition (SVD), and Tikhonov regularization as known in the art of image processing.

Once the matrix S is calculated from the image acquired by laser scan microscopy image, it can be used for reconstructing the locations, optionally and preferably three-dimensional locations, of the individual elements in the volume as imaged by the temporal focusing system. When the imaged volume is generally static wherein the elements in the volume remain at the same locations with zero or no displacements, the same calculated S can be used for reconstructing the locations from a plurality of acquisitions (e.g., 100, 1,000, 10,000, 1,000,000 or more) by the temporal focusing system. These acquisitions can be used for providing a dynamic data steam of the imaged volume. Thus, for example, when the imaged volume includes neurons, a plurality of acquisitions by the temporal focusing system, each being processed by the matrix S as calculated from the laser scan microscopy image, can be used to provide imagery data pertaining to the activity of the neurons in the volume as a function of the time.

As used herein the term “about” refers to ±10%.

The word “exemplary” is used herein to mean “serving as an example, instance or illustration.” Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments.” Any particular embodiment of the invention may include a plurality of “optional” features unless such features conflict. The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental support in the following examples.

### EXAMPLES

Reference is now made to the following examples, which together with the above descriptions illustrate some embodiments of the invention in a non limiting fashion.

### Example 1

A prototype rapid 3D scanning microscope system, based on line-scanning temporal focusing has been constructed. A high-efficiency temporal focusing setup, with flexible axial scanning mechanism, enabled both fast and large-scale scanning. The system included a rapid low-noise EMCCD camera with imaging rate of up to 200 frames/sec. The system was capable of imaging a volume of 250 μm×500 μm×200 μm with 4 μm lateral resolution, 10 μm axial resolution and repetition rate of up to 20 volumes/sec. The system also allowed increasing the imaged volume depth and decreasing the temporal or the axial resolution.

The prototype imaging system was combined with a standard two-photon laser scan microscopy (TPLSM) setup, which allowed acquiring high spatial resolution TPLSM images as well as high temporal resolution temporal focusing images. The images were merged to gain high spatial and temporal dynamic volumetric imaging.

The switching between the TPLSM mode and the line-scanning temporal focusing mode, included replacing the scan lens of the TPLSM with a cylindrical lens and dual prism grism. The dual prism grism was designed such that the laser's central wavelength first-order diffraction is transmitted in the same direction as the impinging light. The transmission efficiency of the dual prism grism was 90%, significantly higher than the efficiency of a typical reflection grating.

The light detection system of the TPLSM included a photomultiplier tube and the light detection system of the temporal focusing system included a camera. This was implemented by mounting a dichroic mirror on a rotating base with the ability to direct the fluorescent light toward either the photomultiplier tube or the camera.

Thus, switching from one imaging modality to the other was made by replacing an optical unit and rotating a dichroic mirror (see FIG. 6).

Several additional improvements were made in the TPLSM system. A regenerative amplified oscillator, which significantly enhanced the two-photon absorption and enabled simultaneously illuminating a 250 μm length line, was employed. In order to enhance axial scanning range and speed, a Piezoelectric based motor, which enabled to axially scan a distance of 200 μm at 20 volumes/sec or distances large as 2 mm at 10 volumes/sec, was used.

For the temporal focusing system, an EMCCD camera, which enabled rapid low-noise image acquisition, was used.

Scanimage software was used to control the TPLSM microscope and a custom MATLAB® software was developed to control the temporal focusing microscope. The custom software moved one scanning mirror to scan the temporally-focused line laterally, moved the objective axial scanning system, sent triggers to the EMCCD camera, and turned on and off the Pockels cell which controlled the laser beam power. The timing of these four components was selected to complete one lateral scanning each frame, to assure that each frame is taken in a known depth inside the tissue and that the laser power is be down during the EMCCD readout period.

In accordance with the scan range of the piezo-based motor (up to 2 mm at 10 Hz), and the acquisition rate of the camera (up to 200 frames per second), the available range of scanning parameters were from scanning a range of 200 μm with 10 μm axial resolution, to scanning 2 mm of tissue with sampled planes each 100 μm.

A repetitive triangular shape signal was applied to the motor, while images were take with phase shift of a quarter of the camera acquisition time, this way images in the way back were taken in between images that were taken in the way front.

### Example 2

A system similar to the system described in Example 1 was built and used for imaging three-dimensional neuronal cultures.

The characteristics of the system were line scanning at 2.5 ms, axial scanning at 100 ms, depth of 200 μm depth, EMCCD acquisition rate of 200 frames/sec, lateral resolution of 3 μm, and axial resolution of 13.3 μm (20×, NA=0.5 objective). The imaging rate was 180 planes per second.

The neuronal cultures were grown inside a transparent hydrogel for 5 to 12 days, and were stained by Fluo-4 calcium sensitive indicator. The size of the sample was 150 μm×400 μm×200 μm.

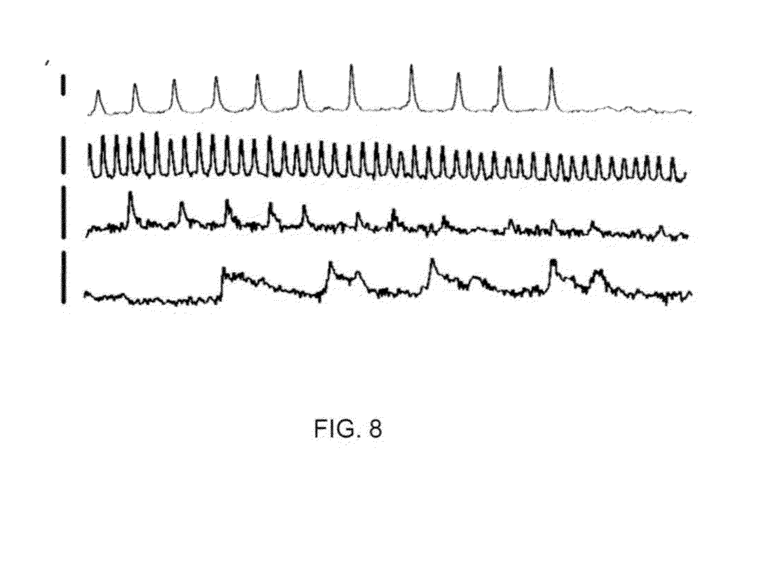

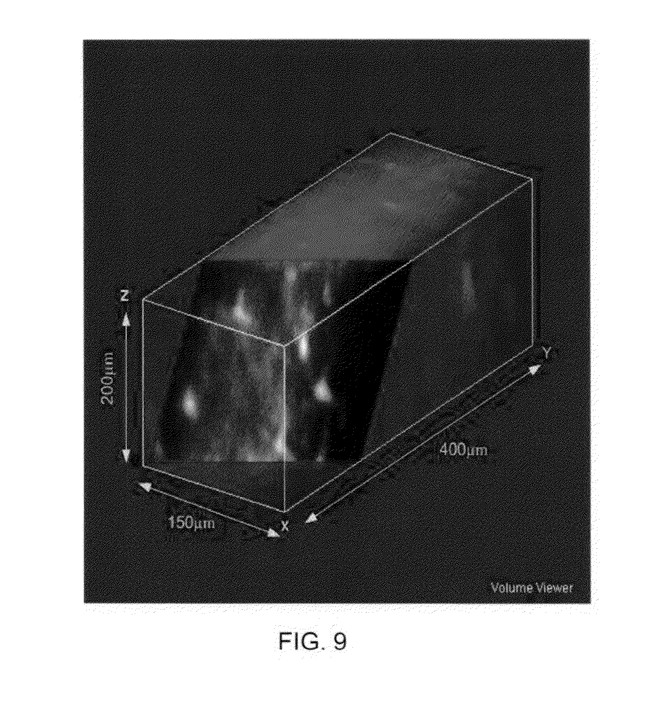

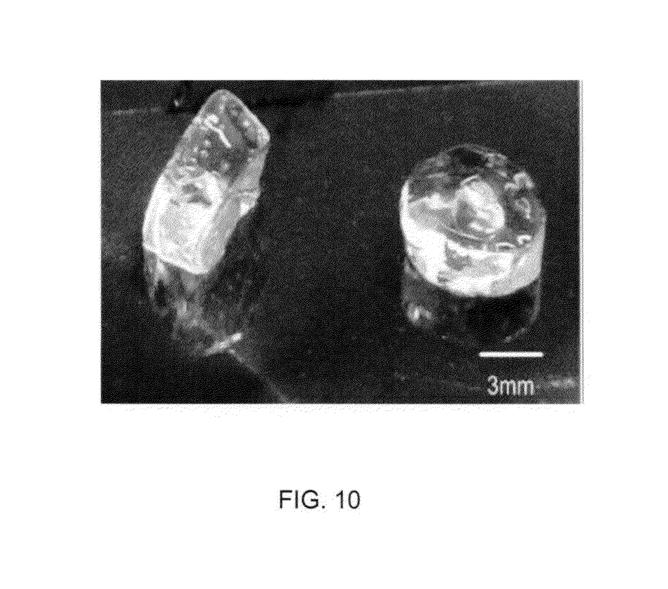

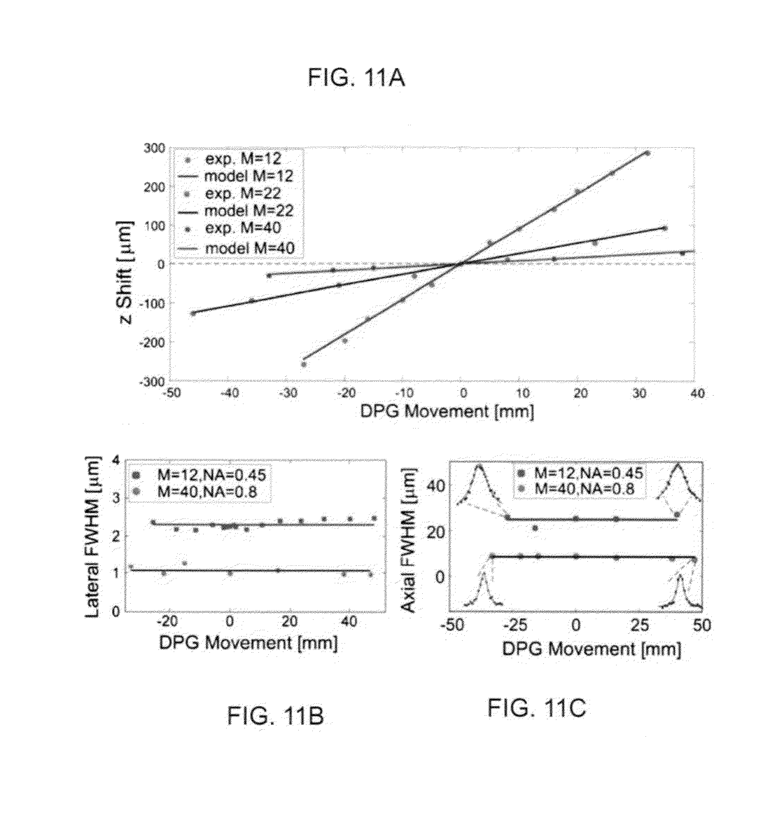

The results of the experiments are shown in FIGS. 7-10. FIG. 7 shows the two-dimensional structure of neural cells stained with the fluorescent calcium indicator Fluo-4 that were imaged with the temporal focusing imaging system. FIG. 8 shows calcium transients in these cells as a result of neuronal activity (i.e. firing of action potentials). FIG. 9 shows three-dimensional structure of neural cells in vitro that were acquired by the temporal focusing imaging system, and FIG. 10 are images of the transparent hydrogel used in the experiment.

### Example 3

The location of the focal plane as a function of the position of the prismatic element was tested in a temporal focusing setup constructed according to some embodiments of the present invention. It is noted that in Durst et al., Opt. Express 14, 12243 (2006) it was argued that temporal focusing is not suitable for remote scanning. The experiment included a custom-made DPG, with anti-reflection-coated prisms (48°×42°×90°, BK7 glass), a 1200 lines/mm transmission grating, and a measured efficiency of 85% (versus about 87% predicted for both polarization states). The DPG was designed for an 800 nm central wavelength that hits the grating and is diffracted at 18°, and has a narrow working bandwidth (790-810 nm).

The remote scanning performance was measured in the line-illumination setup as illustrated in FIG. 2 by illuminating a thin layer of fluorescein solution using an amplified ultrafast laser (Coherent RegA 9000, 200 fs), and three different objectives (Zeiss ×10 NA=0.45, Olympus ×20 NA=0.5, and Nikon ×40 NA=0.8; magnification was 12, 22, and 40 respectively, since a tube lens with f=200 mm was used). The line was imaged using a detection system consisting of an objective lens (Zeiss ×10 NA=0.45 and Olympus ×20 NA=0.5), a second lens (f=200 mm), and a CCD (UEye 2220SE-M). Both the sample and the detection objective lens were mounted on precision manipulators (Sutter MP-285 and MP-225, respectively).

The DPG and cylindrical lens were mechanically moved and the movement of the focal plane and the new optical sectioning were measured. The prismatic element and cylindrical lens were mechanically moved and the movement of the focal plane and the new optical sectioning were measured.

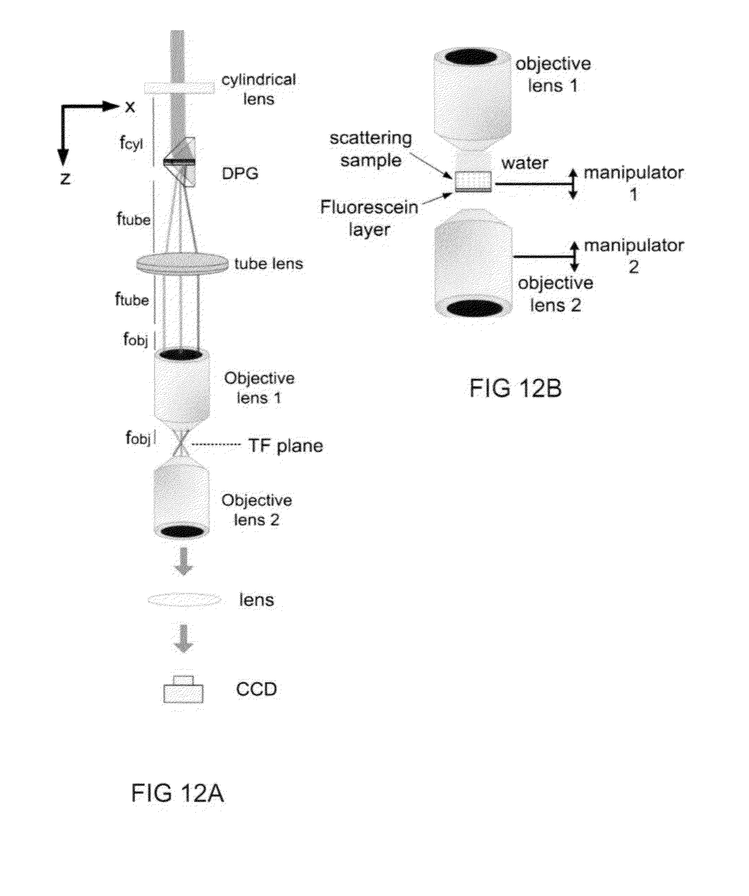

FIGS. 11A-C shows the experimental results and model prediction from Geometrical and Gaussian optic matrix calculation for light propagation through the optical setup which yield the following relation for the focal plan movement:

d=D/(M²n₁/n₂)

where d is the focal plane movement, D is the translation of the prismatic element and cylindrical lens, M is the tube lens and objective lens magnification, n₁ is the refractive index of the medium before the objective lens (air) and n₂ is the refractive index of the medium between the objective lens and the sample (water).

FIG. 11A shows the Axial Shift of the focal plane as a function of the movement of the prismatic element and cylindrical lens for two different magnifications. The dots represent experimental measurements and the solid lines are according to the above equation. FIGS. 11B and 11C show lateral and axial sectioning of the illumination line for different focal plane shift. No significant change was observed for scanning range of more r=than 600 μm (M=12). The insets in FIG. 11C show individual measurements of axial sectioning, fit by Cauchy-Lorentz function.

FIGS. 11A-C also demonstrate that the lateral and axial sectioning do not significantly change for a DPG scanning range exceeding 65 mm. Vignetting and aberrations are expected to eventually deteriorate these performance measures, but significant deterioration does not appear to occur within the spatial constraints of the experimental system. It is noted that pulse dispersion contributed by the about 3 cm of propagation in the prism's glass (about 1500 fs²).

The present Example demonstrated the ability of the present embodiments to control the location of the focal plane by varying the location of the prismatic element.

### Example 4

In the present example two alternative line temporal focusing (LITEF) optical setups are presented.

A first setup uses a cylindrical lens to focus a laser beam to a line on a diffraction grating (perpendicular to the grooves direction), and tube and objective lenses in a 4f configuration to image the grating surface onto the objective's front focal plane. In a second setup, the laser beam hits the grating surface directly, and a 4f configuration of a cylindrical and objective lenses is used to image the grating's surface onto the objective lens front focal plane.

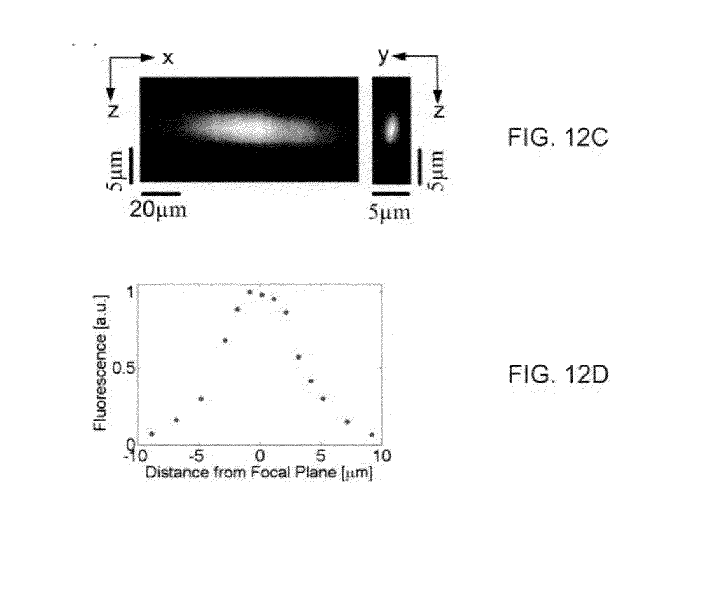

In both setups, the diffraction grating separates the incoming laser beam to its spectral components (in the x axis), and they re-unite in the objective focal plane where the sample is located and the grating surface is imaged. The spectral separation (in the xz plane, see FIG. 12A) results in pulse temporal stretching, which is compressed back to its original duration in the focal plane and re-stretched after it.

Since multiphoton processes are sensitive to pulse duration, effective excitation is achieved only near the focal plane and optical sectioning without spatial focusing of the beam is attained. In the perpendicular (yz) plane the beam reaches the objective back aperture collimated and is focused to a line in the objective focal plane. The interactions of the illumination light with the medium in which it propagates (e.g., scattering) affects the performance of widefield temporal-focusing (WITEF), causing the axial sectioning to deteriorate much faster than in scanning (spatially focused) two photon microscopy.

FIGS. 12A-D illustrate the outline of the experimental procedure. FIG. 12A illustrates a LITEF optical setup and inverted detection setup. Laser beam is focused by a cylindrical lens to a line (y axis) on the DPG transmission grating surface; the DPG is designed to diffract the laser beam and maintain the laser's central wavelength in the same propagation direction. The tube and objective lenses image the grating surface onto the objective focal plane, where the pulse duration is minimal. The detection microscope uses a second objective and another lens to image the fluorescence on a CCD.

FIG. 12B is a more detailed view of the sample region. Scattering samples were set over a 5 μm layer of fluorescein. Measurements were obtained by axially moving objective 2 and the sample.

FIG. 12C shows xz and yz projections of images taken at different distances from the TF focal plane using Nikon 40× NA=0.8 objective (beam waist 0.75 μm, line length 125 μm).

FIG. 12D shows measurements (dots) of axial optical sectioning of the data shown in FIG. 12C.

### Methods

### Setup

The experimental setup is illustrated in FIG. 12A. It is based on an upright LITEF microscope that illuminates a sample from above (optionally, the sample is located under a scattering medium), and an inverted microscope which images the sample from below without encountering scattering effects on the emitted light. The LITEF path uses a dual-prism grating (DPG) which consists of a transmission diffraction grating embedded between two prisms. The prisms angles (48°×42°×90°, BK7 glass) and the diffraction grating groove density (1200 lines/mm) are designed to refract and diffract the laser's central wavelength (800 nm) toward the same direction of the incoming light propagation. The DPG based design simplifies the optical setup configuration, offers a high efficiency (85% measured efficiency vs. 87% predicted efficiency for both polarization states), and also allows to perform remote scanning of the focal plane.

The excitation source is an amplified ultrafast laser (RegA 9000, pumped and seeded by a Vitesse duo; Coherent), providing up to 200 mW of average power at the sample plane at a 150 KHz repetition rate (1.33 μJ/pulse). After passing through a beam expander, an electro-optic modulator (Conoptics), and a cylindrical lens (f=75 mm), the beam hits the DPG and reaches the grating tilted by an angle α′=18°. An f=200 mm tube lens (Nikon) was used together with three interchangeable objective lenses (Nikon 60× NA=1, Nikon 40× NA=0.8, and Zeiss 10× NA=0.45. The latter combined with the Nikon tube lens had an actual magnification of 12; all objectives are water immersion) in a 4f configuration to image a temporally focused line onto the sample. A scattering tissue phantom was placed on top of a 5 μm fluorescein layer near the objective's focal plane (see FIG. 12B; the fluorescein layer thickness was measured using TPLSM axial scanning). This phantom mimics the scattering characteristics of cortical tissue with mean free path (MFP) of 200 μm and scattering anisotropy of g=0.9.

To measure the fluorescence light intensity from the opposite side of the sample, as well as to estimate the illuminated line waist, a second objective lens (Olympus 20× NA=0.5 water immersion, and Nikon 40× NA=0.55 air), an imaging lens and a CCD camera (UEye 2220SE-M, IDS) were used.

The sample and the second objective lens were mounted on two micromanipulators (MP-285 and MP-225 respectively, Sutter), which were used to move the sample and the detection system to controlled distances from the TF plane with 1 μm steps. The thickness of the scattering medium above the fluorescein layer was measured by moving the sample from the scattering medium top to the fluorescein layer, measuring the distance, and subtracting the thickness of a cover slip (average thickness of 150 μm) that lies between them.

Pulse duration of ˜200 fs was measured at the laser's output using an autocorrelator (PulseCheck, APE). At the TF focal plane (after passing through all of the optical components) a similar pulse duration was estimated by fitting a WITEF optical sectioning measurements (i.e. by removing the cylindrical lens) to model predictions for different pulse durations.

Optical sectioning curves were calculated by integrating the fluorescence signal from an image acquired for each distance from the focal plane. All comparisons of model predictions to experimental measurements were compensated for the broadening introduced by the finite thickness of the fluorescein layer (see example in FIG. 12D).

### Computational Model

The model assumes independent light propagation in the mutually-perpendicular spatial and temporal focusing planes (yz and xz planes, respectively). The original WITEF model geometry is two dimensional and describes light propagation in the optical axis and the spectral distribution axis (z and x axes, respectively). Here, we add an additional description for the propagation in the spatial focusing plane using a cylindrical Gaussian beam model in the y axis. In addition, our experimental setup now includes a DPG made of BK7 glass (see section 2.1 for details), which we incorporated into the model.

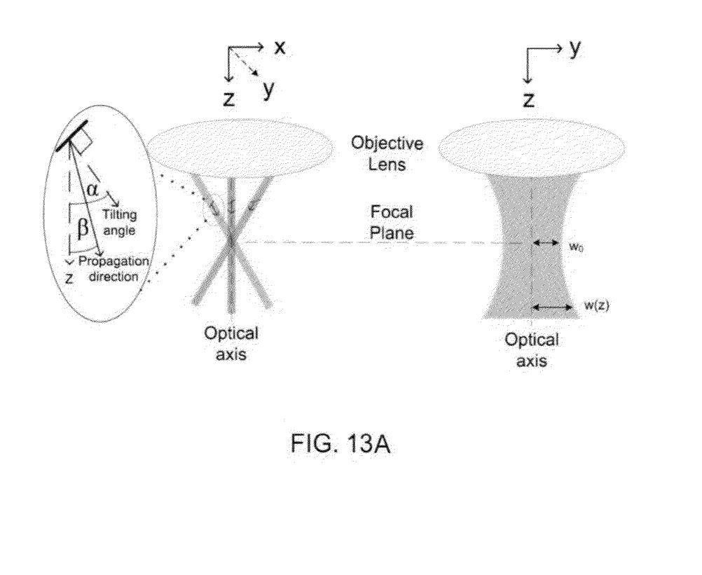

FIGS. 13A-D show numerical simulation of LITEF light propagation. FIG. 13A shows a schematic demonstration of light propagation in temporal and spatial focusing planes (xz and yz respectively), near the objective lens focal plane. Different colors in the xz planes represents different spectral components, each one is propagating in a different direction (β) and tilted in a different angle (a). FIG. 13B is a snapshot of light propagation on the optical axis (in logarithmic scale), taken from the simulation. FIG. 13C shows projections of simulated LITEF illumination of 5 μm fluorescent layer (blurring by imaging system was not simulated). FIG. 13D shows optical sectioning curves for thin fluorescent layer (thickness practically approaches 0, blue line) and 5 μm fluorescent layer (black line). Optical parameters: M=40, NA=0.8, w₀=0.75 μm, 1=50 μm.

When a delta pulse is focused into a line and impinges upon a diffraction grating (FIG. 12A), each spectral component is diffracted to a different direction and propagates a different optical path towards the focal plane. The propagation in the xz plane near the focal plane was previously described in detail. Briefly, each spectral component propagates in a direction angle β as a tilted line, with tilting angle α. The spectral components reunite in the focal plane and scan it together within picoseconds. The scanning speed depends on the angle α′ with which the incoming delta pulse phase front is tilted with respect to the diffraction grating, on the system's magnification M, and on the DPG material (with refraction index n_{DPG}) and is given by c/(n_{DPG}·M·sin α′). On the other hand, the focal plane is located in a medium with refractive index n_{f}, and is scanned by a line that propagates in direction β and is tilted by angle α with a scanning speed of c·cos(α−β)/(n_{f}·sin α). The focal plane is the image of the grating's surface, and according to Fermat's principle, the scanning time is equal. Therefore:

$$α = {cot}^{- 1} ( \frac{{n}_{f} / {n}_{DPG}}{M sin {α}^{′} cos β} - tan β )$$

β values correspond to each spectral component propagation direction and their maximal value is limited by the objective's NA. The spectral component line length is derived from the illuminated line length l and from the angles α and β, and is given by l cos β/(cos(α−β)). The beam spectral profile was assumed to be Gaussian, and its 1/e width before arriving to the objective lens was estimated to be equal to the objective's back aperture diameter.

The propagation scheme in the yz plane is different. In this plane the cylindrical lens and the tube lens generate a telescope and the light reaches the objective lens nearly collimated. Each spectral component was modeled as a cylindrical Gaussian beam in the yz plane, with an equal minimal waist (w₀) which is obtained in the focal plane (see FIG. 12B). The w₀ value was experimentally measured for each objective, and was corrected for the imaging PSF. The two-dimensional Gaussian beam formula is given by

$$I ( y , z ) = {I}_{0} ( \frac{{w}_{0}}{w ( z )} ) exp ( \frac{- 2 {y}^{2}}{{w}^{2} ( z )} ) .$$

Therefore, each spectral component is characterized by its length, its tilting angle α, its propagation direction β, all in the xz plane, and its waist size w₀, in the yz plane.

In order to introduce tissue scattering effects into the model, we computed scattering kernels for various scattering depths, using a time-resolved Monte-Carlo simulation. The medium parameters were: scattering MFP of 200 μm, g=0.9 and negligible absorption. Upon entering the scattering medium, the different spectral elements' intensity distributions are convolved with the matching scattering kernels. Since each spectral component has a different orientation as it propagates inside the scattering medium, we rotated the matching scattering kernel by the same angle to simulate the scattering directions.

### Results

### Model Validation

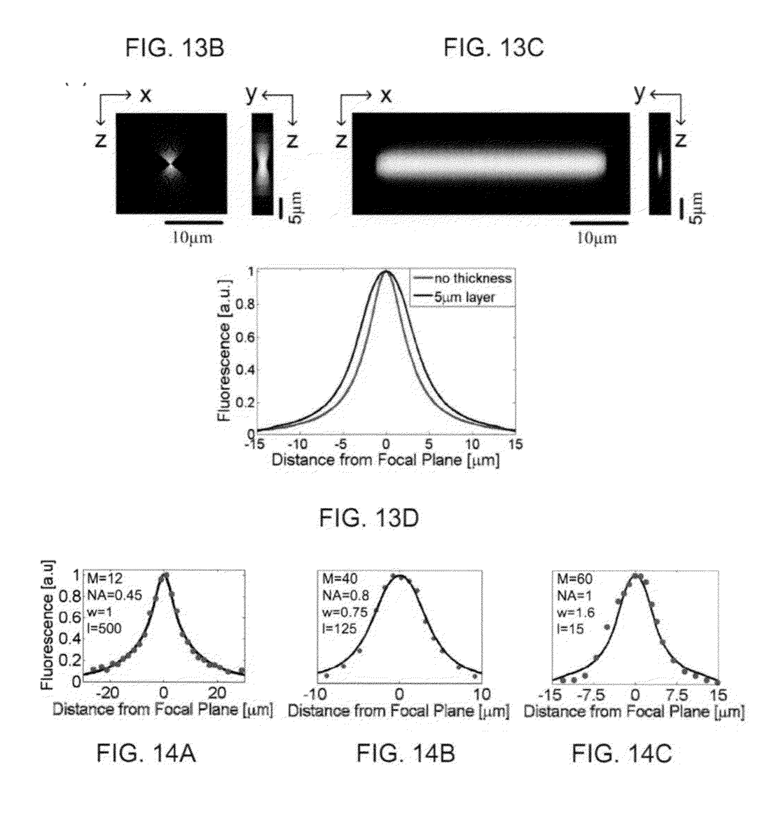

The predictions of the model were tested for optical sectioning width. Optical sectioning was experimentally measured by axially scanning a 5 μm layer of fluorescein solution across the focal plane. Results of these measurements and model predictions for three different optical setup parameters are shown in FIGS. 14A-C. Shown in FIGS. 14A-C are the measured axial optical sectioning (dots) and model's prediction (lines) for three sets of indicated optical parameters (200 fsec pulses).

The optical parameters were chosen to demonstrate LITEF capabilities for different applications: the first set of parameters (M=40, NA=0.8, line length=125 μm, beam waist=0.75 μm) represents commonly used system parameters for high resolution two-photon imaging, while the second set (M=12, NA=0.45, length=500 μm, waist=1 μm) is more suitable according to some embodiments of the present invention for high resolution large field-of-view imaging. The third set (M=60, NA=1, length=15 μm, waist=1.6 μm) was selected in accordance with some embodiments of the present invention for ultra-deep imaging.

### Dependence on Optical Parameters in Non-Scattering Media

The present inventors found an approximate formula that fits LITEF optical sectioning in transparent media. The sectioning profile of both the model predictions and the experimental measurements are consistently well fit with an analytical product of two square-roots of Lorentz-Cauchy functions given by:

$$F = \frac{1}{\sqrt{1 + {( z / {z}_{R 1} )}^{2}} \cdot \sqrt{1 + {( z / {z}_{R 2} )}^{2}}}$$

where F is the (peak-normalized) fluorescence signal and z is the axial distance from the TF focal plane. The optical sectioning parameters z_{R1} and z_{R2} depend only on the temporal and spatial focusing, respectively, highlighting the separation of the two independent effects.

The first function in the product describes the sectioning due to the temporal focusing, and depends on the microscope's magnification, NA (in the TF plane), the illuminated line length and the laser's pulse duration. The second function describes the sectioning due to the spatial focusing and depends only on the beam waist, namely on the objective's NA in the spatial focusing plane.

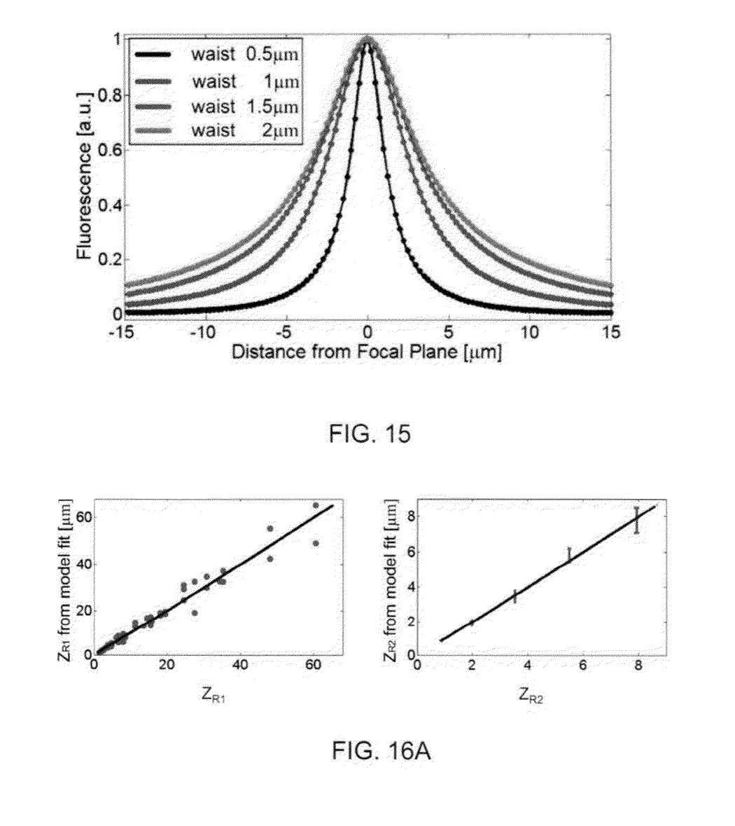

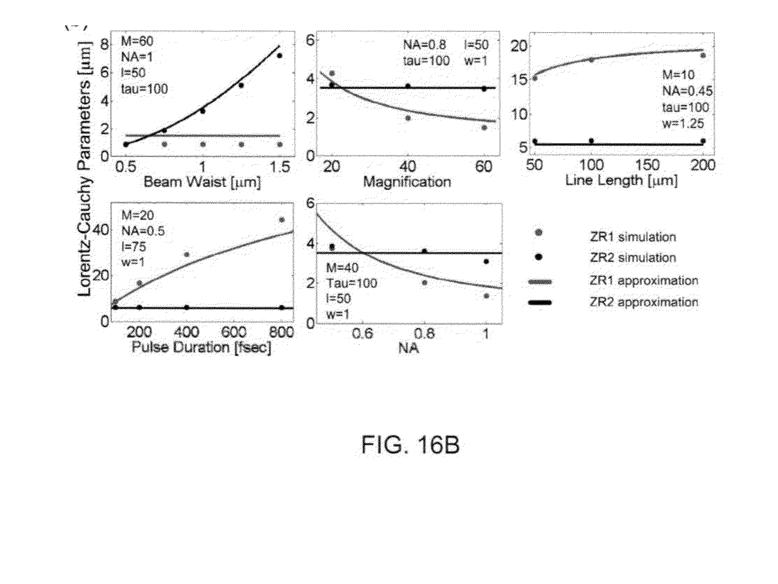

Examples of fitting the function F to the model's results are shown in FIG. 15, in which the optical parameters are M=20, NA=1, l=50 μm and tau=100 fsec. It was also found that for a wide range of parameters (magnification 10-60, pulse duration 100-400 fsec, numerical apertures 0.45-1, line length 5-200 μm, and beam waist 0.5-1.5 μm), the dependence of z_{R1} and z_{R2} on the optics can be well-approximated by the following expression:

$${z}_{R 1} = {k}_{1} + \frac{τ}{{k}_{2} \cdot \frac{τ}{l} + {k}_{3} \cdot M \cdot {NA}^{2}} , \\ {z}_{R 2} = {k}_{4} \cdot {w}_{0}^{2}$$

where k₁=0.82, k₂=0.88, k₃=2.44, k₄=3.52 are constants, which generally depend on additional system parameters such as α′ value, objective filling profile, grating characteristics, and laser spectral profile. Plots presenting the overall quality of the approximation are shown in FIG. 16A, and representative dependencies of the optical sectioning on each model parameter are shown in FIG. 16B. Specifically, FIG. 16A is a scatter plot of the estimated Lorentz-Cauchy parameters Z_{R1} and Z_{R2}. The left panel shows a scatter plot of Z_{R1} corresponding to the above equations for F, and the right panel shows the scatter plot of Z_{R2} corresponding to the approximated equation for Z_{R1}. The error bars in the right panel indicates standard deviation. FIG. 16B shows a comparison of model calculated optical sectioning (dots) to the equations for F and Z_{R1} (lines). Optical parameters are indicated next to each graph in FIG. 16B.

### Scattering Effects

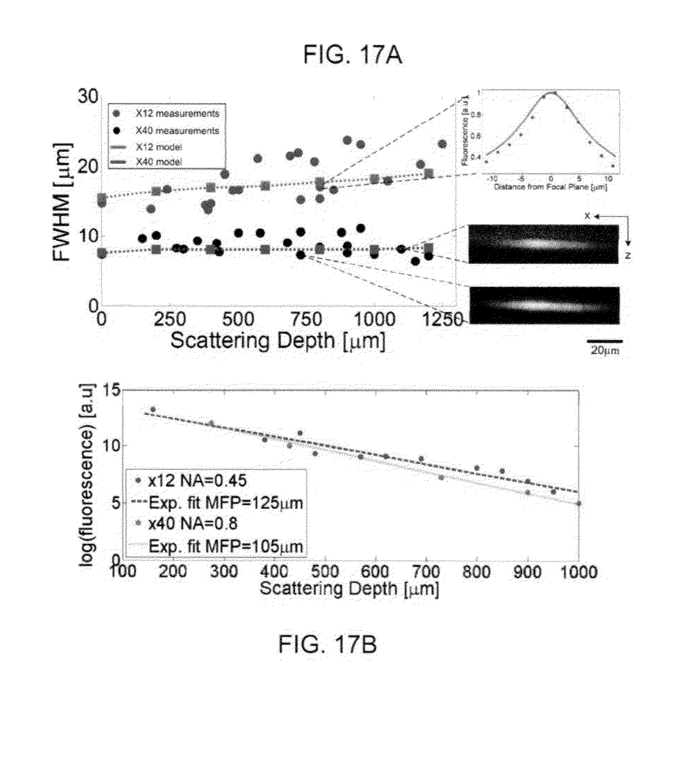

The scattering effects are shown in FIG. 17A-B. FIG. 17A shows optical sectioning of two optical setups at different scattering depths. Dots represent experimental measurements, rectangles are model calculations results, connected with solid line. Insets show model's prediction vs. experimental measurements, and xz projection images taken at specific points in the graph. Optical parameters: 1) M=12, NA=0.45, l=500 μm, w=1 μm, tau=200 fsec. 2) M=40, NA=0.8, l=125 μm, w=0.75 μm, tau=200 fsec. FIG. 17B shows measured attenuation of the LITEF signal (logarithmic scale) as function of scattering phantom thickness, fitted by an exponent function. Signal attenuation is slower than TPLSM but faster than WITEF

The use of an amplified laser source enabled the measurement of light penetrating through more than 1 mm of the scattering phantom—these measurements and model predictions were compared for two different optical setups (FIG. 17A). According to both the theoretical and experimental results, LITEF exhibits a relatively slow deterioration of the optical sectioning with scattering depth: no significant broadening was measured for the small field of view setup, and a broadening by a factor less than 1.5 was measured in the large field of view configuration at a depth of 6 scattering MFPs. For comparison, WITEF exhibits a more significant broadening over a range of 2.5 MFPs. The Fluorescence signal power as a function of depth under scattering media was also measured (FIG. 17B). The fluorescence signal exponential attenuation fit corresponds to an MFP of 127 μm for the ×12 NA=0.45 setup and 105 μm for the ×40 NA=0.8 setup, compared to 100 μm MFP expected for pure spatial focusing.

### Deep Tissue Penetration

According to some embodiments of the present invention an imaging technique suitable for deep tissue imaging using temporal focusing is provided. The technique optionally and preferably comprises illuminating a temporally-focused line, preferably a short line (e.g., less that 50 μm or less that 40 μm or less that 30 μm or less that 20 μm or less that 10 μm in length, for example, 5 μm or less), and raster scanning the line over a region of interest.

Such imaging was experimented by the present inventors by removing a beam expander from the setup and using a high magnification objective (×60, NA=1) illuminated a 15 μm-long temporally focused line onto the 5 μm fluorescein layer under scattering phantoms. Removing the beam expander reduced the filling of the objective, and a beam waist of 1.6 μm was measured. Penetration of more than 9 scattering MFPs into the scattering phantom were measured without significant loss of optical sectioning.

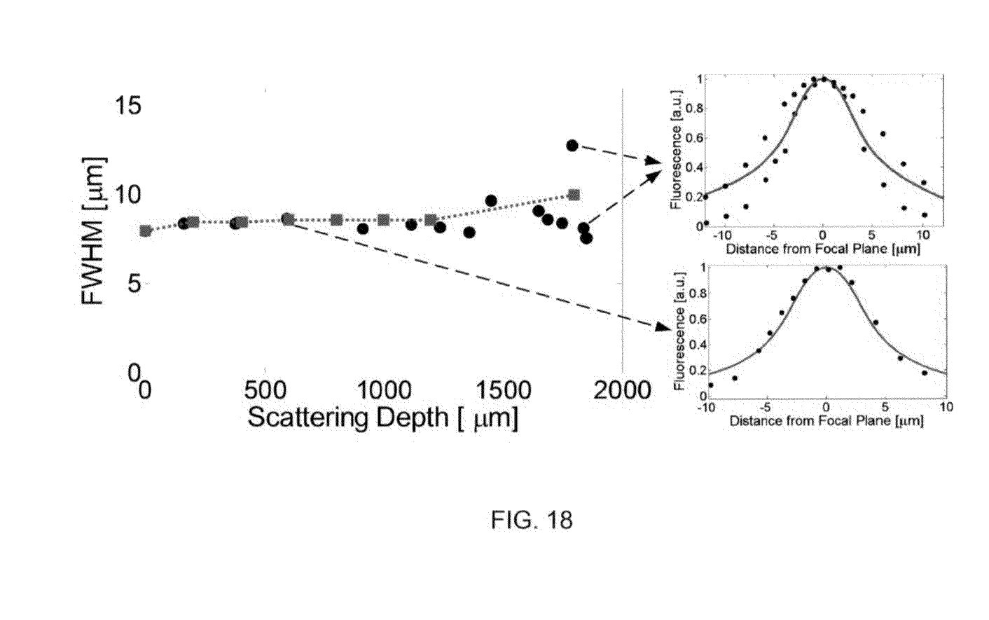

An example of ultra-deep penetration into scattering phantom is shown in FIG. 18. The dots represent experimental measurements, the rectangles are model calculations results, connected with solid line. The insets show optical sectioning measurements and their model predictions for specific depths.

When the line length is reduced to, for example, 5 μm and the objective's filling is optimized, optical sectioning of about 2 μm is expected. Therefore, the method optionally and preferably can be used to penetrate very deep into tissue, beyond what is possible with conventional imaging methods.

### Example 5

In this Example, a procedure for data extraction from blurred images is we described. A-priori structural knowledge obtained by TPLSM is combined with a model for image blurring in a camera based imaging system. This model is used to invert the blurring effects and extract cells functional information from movies of blurred images. Simulations predict that the presented approach is capable of extracting functional data information for depths of more than 500 μm inside brain-like tissues, even in cases of severe noise.

### Methods

### Light Propagation Description

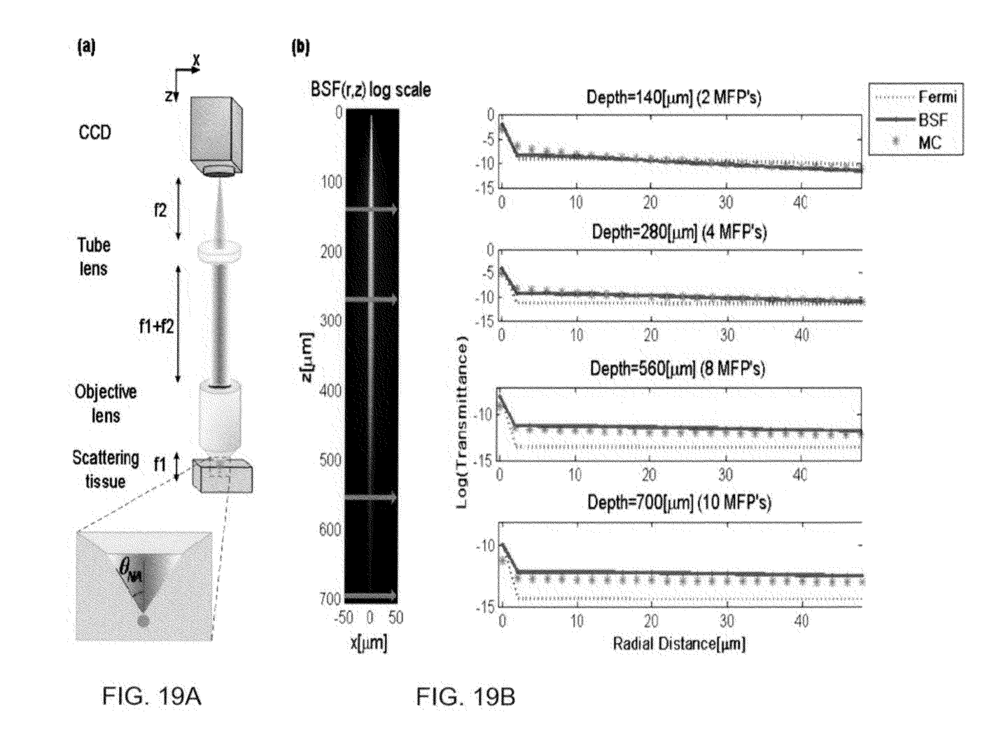

In this section an image formation model inside a scattering medium is presented. The propagation of an isotropic fluorescence light source from its origin, through a scattering medium and an optical system of lenses, until it reaches a camera is analyzed. FIG. 19A is a schematic illustration of the studied imaging setup. A fluorescence point source is located inside a scattering medium, and a standard imaging system with magnification of 15, images it onto a CCD camera. Due to scattering effects, the point source image is blurred.

An analytical model for estimating scattering effects was adopted, since it approximates variables that are not accessible through Monte-Carlo numerical simulations, such as the distribution of propagation directions in each point in space. After leaving the scattering medium, photons propagate according to geometrical optics approximation.

### Light Propagation in Scattering Media

Several analytical models for light propagation analysis, were tested and their accuracy were validated for the relevant parameters range: short scattering MFP (about 70 μm for visible light in cortical tissue), penetration of several MFPs into the tissue, and forward scattering which is described by Henyey-Greenstein phase function (g≈0.9).

Two analytical models were chosen to calculate tissue scattering effects. Fermi model which is obtained after incorporating simplifying approximations to the RTE, such as forward scattering and small angle approximation, has a simple analytical solution, which is computationally efficient but its accuracy is limited to few MFP's.

Another model is the beam spread function (BSF) model. This model does not rely on the small angle approximation and also takes into account time dispersion of the pulse.

Both model analyzes the light distribution in the spatial variables (x,y,z), angular variables of the light direction (φ and θ, which are the azimuthal and polar angles respectively), and the BSF model also uses the temporal variable (t). Light distribution, according to these models, is a probability function of a photon to reach a depth z±dz/2, position (x±dx/2, y±dy/2), direction (φ+dφ/2, θ±dθ/2) at time (t±dt/2) (for the BSF model only), and is given in a closed-form formula.

FIG. 19B shows comparison of a beam spread function (BSF) model predictions for light radial distribution with Monte-Carlo simulations for different scattering depths (MFP=70 μm, g=0.9).

The Fermi model gives less accurate description of light scattering in deep tissue than the BSF model. The time dependent BSF model demonstrates good agreement with numerical simulations for up to 10 MFP's (700 μm).

Light Propagation Through the Optical System

The scattering effects on a commonly used imaging setup, composed of two lenses (objective and tube lenses) in 4f configuration, magnification of M=15, and NA=0.5 (water immersion) were analyzed. This optical system images a fluorescence point source, which is located in a known depth inside a scattering media. The fluorescence signal is emitted isotropically, but the objective's NA determines a cone, in which the light is collected. The detected fluorescence signal is approximated by superposition of 17 BSF pencil beams, which travel in various directions inside the objective's detection cone. Contributions of light that is emitted in an initial angle that is out of the NA cone and scattered back into it while traveling inside the tissue, were neglected.

After propagating inside the scattering medium, the ballistic and scattered photons leave to the surrounding medium (water in our model, the small change in refraction index was neglected), and continue to propagate in straight lines (geometrical optics approximation) through the lenses and the free space between them until it reaches the CCD surface. FIG. 19A shows a schematic representation of the studied imaging system. Such propagation, in xz plane (z is the optical axis), is described by product of the appropriate transfer matrices:

$${M}_{system} = {\underbrace{[ \begin{matrix}1 & {f}_{2} \\ 0 & 1\end{matrix} ]}}_{{Free space}_{propogation}} {\underbrace{[ \begin{matrix}1 & 0 \\ - 1 / {f}_{2} & 1\end{matrix} ]}}_{Tubelens} {\underbrace{[ \begin{matrix}1 & {f}_{1} + {f}_{2} \\ 0 & 1\end{matrix} ]}}_{{Free space}_{propogation}} \underbrace{[ \begin{matrix}1 & 0 \\ - 1 / {f}_{1} & 1\end{matrix} ]}_{Objective lens} {\underbrace{[ \begin{matrix}1 & {f}_{1} - {z}_{0} \\ 0 & 1\end{matrix} ]}}_{{Free space}_{propogation}} \\ ⇒ [ \begin{matrix}{x}_{CCD} \\ {s}_{xCCD}\end{matrix} ] = {M}_{system} \cdot [ \begin{matrix}x \\ {s}_{x}\end{matrix} ]$$

where x_{CCD} is the spatial position on the CCD surface x axis, and s_{x,CCD} is the angle between the propagation direction in xz plane and the optical axis.

Identical matrix describes the photons arrival for

$$[ \begin{matrix}{y}_{CCD} \\ {s}_{y , CCD}\end{matrix} ]$$

on the CCD. The image obtained on the CCD surface was calculated by integrating over the angular and temporal variables to get a blurred image of the point fluorescence source. This is the depth-dependent PSF of the system. This PSF was well fitted by a combination of a Gaussian and Kronecker delta function for the scattered and ballistic photons respectively.

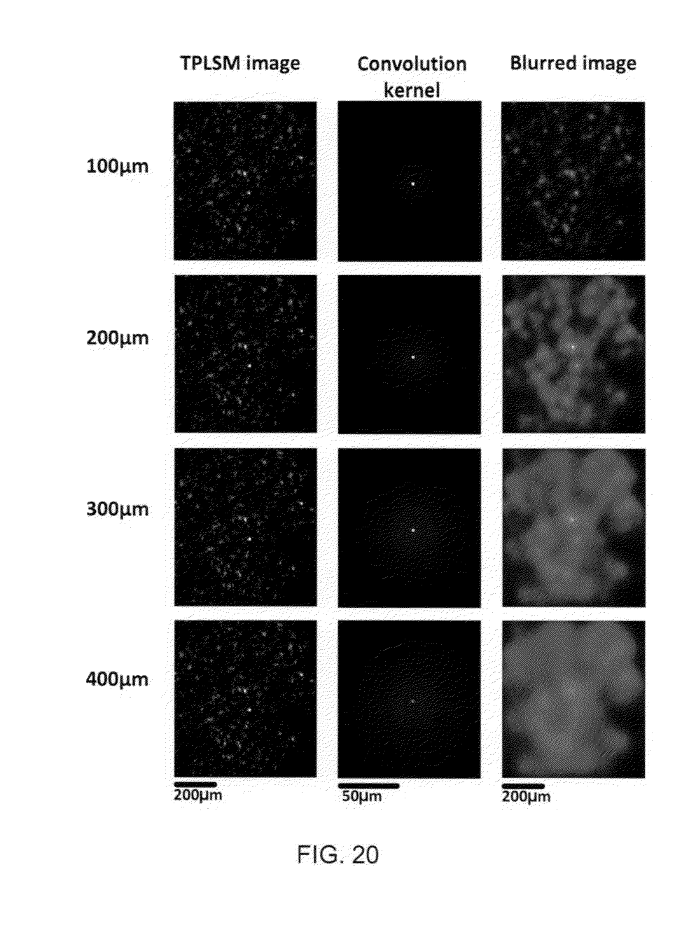

FIG. 20 shows simulation results for blurred images at different scattering depths. As shown, there is a gradual degradation of the blurred images quality. Separation between adjacent cells is challenging from depth of 200 μm, and prevents direct analysis of the cells activity patterns.

To calculate the scattering effect for any known fluorescence image in a given depth, a convolution of the fluorescence signal geometrical shape with the respective depth-dependent PSFs was computed.

### Data Extraction Model

In this section a linear model for extracting neuronal activity patterns from blurred movies of functional volumetric imaging is presented.

Each volumetric image, taken at time point t₁ is represented by a column-stack vector V. This volumetric image is composed of the fluorescence from N different cells; each one of them is blurred by a specific depth-dependent kernel NSF (neuron spread function, analog to the well-known PSF in optics). Each NSF transforms the real shape of a neuron to its blurred shape on the CCD, and is calculated according to the BSF model and the description in the previous section. Since the fluorescence is dependent on the neuron activity in this time point, the NSF is multiplied by an activity indicator Aᵢ. An additive measurement noise was also included.

Mathematically, this model is given by the following equation:

$$\underbrace{[ ( \begin{matrix}{V}_{11} \\ {V}_{12} \\ ⋮ \\ ⋮ \\ ⋮ \\ {V}_{1 j}\end{matrix} ) ( \begin{matrix}{V}_{21} \\ {V}_{22} \\ ⋮ \\ ⋮ \\ ⋮ \\ {V}_{2 j}\end{matrix} ) … ( \begin{matrix}{V}_{L 1} \\ {V}_{L 2} \\ ⋮ \\ ⋮ \\ ⋮ \\ {V}_{Lj}\end{matrix} ) ]}_{V} = {\underbrace{[ \begin{matrix}( ← N S F 1 -> ) \\ ( ← N S F 2 -> ) \\ ⋮ \\ ⋮ \\ v \\ ( ← N S F k -> )\end{matrix} ]}_{S}}^{T} \cdot \underbrace{[ [ ( \begin{matrix}{A}_{11} \\ {A}_{12} \\ ⋮ \\ ⋮ \\ ⋮ \\ {A}_{1 k}\end{matrix} ) ( \begin{matrix}{A}_{21} \\ {A}_{22} \\ ⋮ \\ ⋮ \\ ⋮ \\ {A}_{2 k}\end{matrix} ) … ( \begin{matrix}{A}_{L 1} \\ {A}_{L 2} \\ ⋮ \\ ⋮ \\ ⋮ \\ {A}_{Lk}\end{matrix} ) ] ]}_{A} + \underbrace{[ \begin{matrix}n \\ o \\ i \\ s \\ e \\ \end{matrix} ]}_{n}$$

in which each column in V and A matrices correspond to a single volumetric image (column-stack) and activity indicators vector respectively. L is the total number of volumetric images, j is the total number of voxels in each volumetric image, and k is the number of imaged cells (each one has its specific NSF).

The goal according to some embodiments of the present invention is to solve this equation and find A. The problem can be compactly written as V=S·A+n.

### Results

### Forward Problem: Simulation of Blurred Images Formation

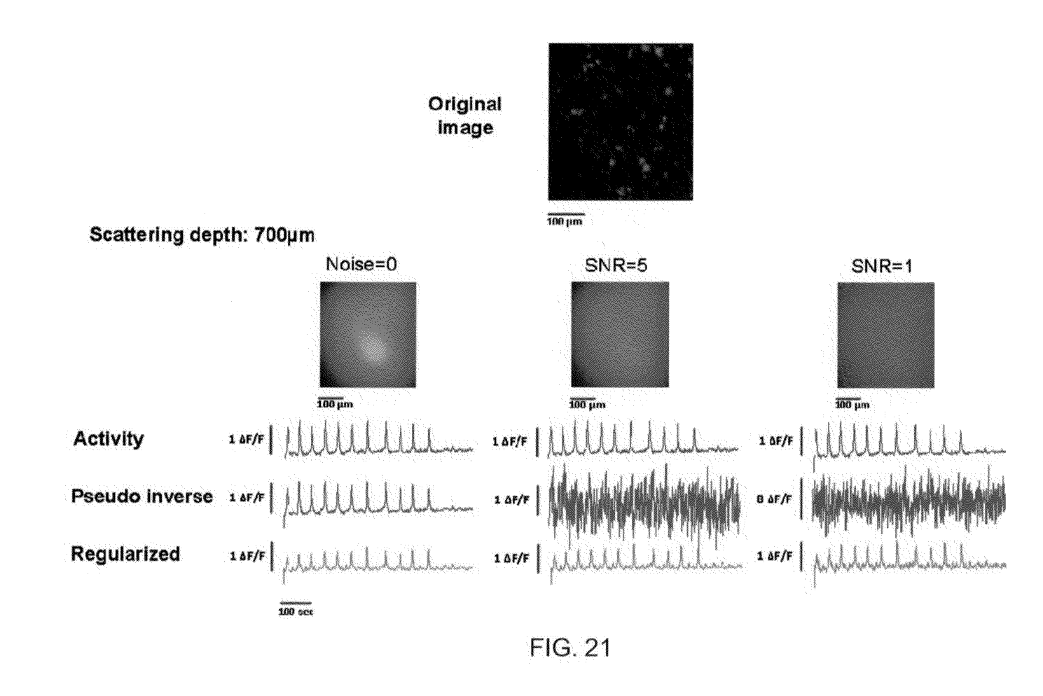

Firstly, the expected blurred images that would be obtained during in vivo imaging were simulated. The simulation starting point was a TPLSM image of neural cells in hydrogel. Since TPLSM images are not blurred by scattering effects, these images were expected to be similar to an image that would be taken in vivo. Next, these images were convolved with the appropriate depth-dependent PSF to predict the expected blurred images for different scattering depths. FIG. 21 shows reconstruction of cells simulated activity patterns at depth of 700 μm, with different noise levels. It appears that separation between adjacent cells becomes challenging at depth of 200 μm.

### Inverse Problem: Neural Data Extraction

The data extraction algorithm of the present embodiments becomes essential for monitoring neuronal activity when individual cells cannot be distinguished visually, and therefore the fluorescence signal from a single cell cannot be isolated. The model of the present embodiments offers for the first time a way to overcome this image blurring limit. This is achieved by utilizing the TPLSM images which contain information regarding the cells' location within the sample.

In order to test the activity reconstruction procedure, the expected volumetric movie of neuronal ensemble of 26 neurons was simulated. 9 neurons were randomly chosen to be active. Activity patterns were taken from experiments in weakly scattering media. In addition to the depth dependent blurring, two sources of noise were added to each pixel: a Poisson noise with mean value that equals the square root of the pixel value, and different levels of Gaussian noise (different mean values, and standard deviation of one third of the chosen mean).

Activity pattern reconstruction was performed from the simulated volumetric movie. By using the above mentioned data extraction model the neuronal activity was retrieved. The present inventors demonstrated that in movies that have little amount of noise the pseudo inverse matrix inversion performs well up to depths of 700 μm (10 MFPs).

A regularized inversion method was tested with an empirically chosen threshold value for inverting the S matrix. This technique gave good results for noise levels of up to SNR=1 and in tissue depth of 700 μm (10 MFPs). The results are presented in FIG. 21.

It is noted that the reconstructed traces shown in FIG. 21 differ from the original signal by bias and a scaling factor. However, since action potentials are point processes, the present study was directed to the extraction of the time in which each action potential has occurred. Action potentials were accurately detected by simple peak detection algorithms. The reconstruction algorithm was tested on various volumatric simulations based on different neural network ensembles. Approximately 81.5% of the active cells' traces were reconstructed successfully under different noise levels as shown in FIG. 5. It is expected that during the life of a patent maturing from this application many relevant regularized algorithms for the solution of the equation will be developed and the scope of the term “calculating a transfer matrix” is intended to include all such new technologies a priori.

### Example 6

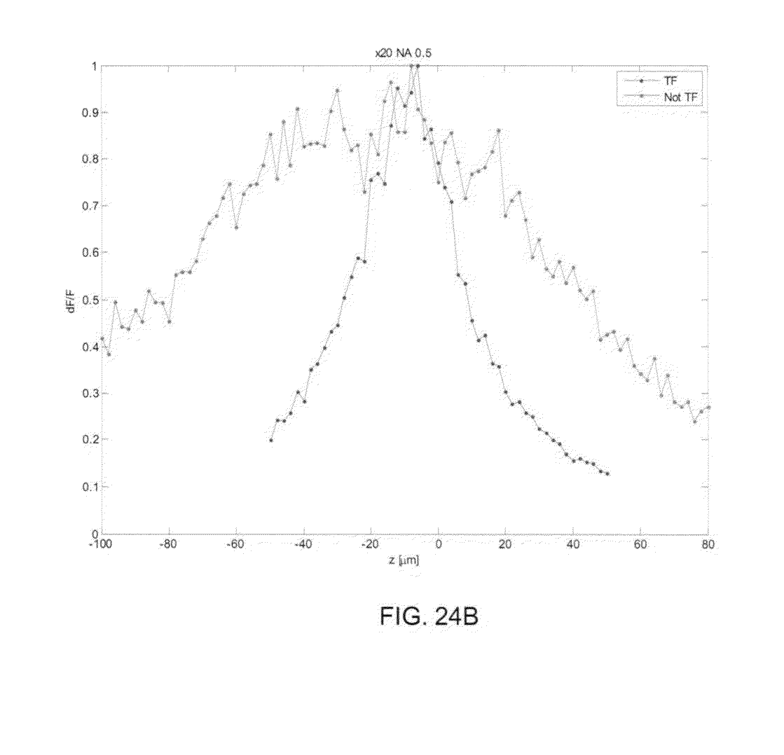

FIGS. 24A and 24B demonstrate the ability of the system of the present embodiments to apply patterned light.

FIG. 24A shows a pattern of 4 illumination spots from the RegA laser projected through the SLM 620 illustrated in FIG. 6. The pattern was calculated using the Gerchberg-Saxton algorithm, projected through an objective lens (20×, NA=0.5) onto a solution containing fluorescein and imaged using a fluorescence microscope and an EMCCD camera.

FIG. 24B shows axial sectioning measurement of the pattern with and without the DPG-based temporal focusing (TF) system of the present embodiments. As shown, the sectioning is greatly improved using the system of the present embodiments.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. An optical system, comprising a temporal focusing system characterized by an optical axis and being configured for receiving a light beam pulse and for controlling a temporal profile of said pulse to form an intensity peak at a focal plane, said temporal focusing system having a prismatic optical element configured for receiving said light beam pulse from an input direction parallel to or collinear with said optical axis and diffracting said light beam pulse along said input direction.

2. The optical system of claim 1, wherein said temporal focusing system comprises a collimator and an objective lens aligned collinearly with respect to optical axes thereof, and wherein said prismatic optical element is configured for diffracting said light beam onto said collimator.

3. (canceled)

4. The optical system according to claim 1, further comprising a spatial manipulating system positioned on the optical path of said light beam pulse and aligned such said spatial manipulating optical system and said temporal focusing system are optically parallel or collinear with respect to optical axes thereof.

5. The optical system according to claim 4, wherein said spatial manipulating system comprises a spatial focusing system.

6. (canceled)

7. The optical system according to claim 4, wherein said spatial manipulating system comprises an optical patterning system.

8. (canceled)

9. The optical system according to claim 1, wherein said prismatic optical element is mounted on a stage movable with resects to said optical axis.

10. The optical system according to claim 9, further comprising a controller for moving said stage.

11. The optical system according to claim 1, further comprising a beam splitting arrangement configured to split said light beam to a plurality of secondary light beams, wherein at least a few of said secondary light beams propagate along an optical path parallel to said input direction, and wherein said temporal focusing system comprises a plurality of prismatic optical elements each arranged to receive one secondary part light beam and to diffract a respective part along a respective optical path.

12. The optical system according to claim 11, further comprising a redirecting optical arrangement configured for redirecting said diffracted secondary light beams such that all secondary light beams propagate in said temporal focusing system collinearly with said optical axis thereof.

13. The optical system according to claim 1, wherein said temporal focusing system is characterized by a numerical aperture of at least 0.5 and optical magnification of at least 40.

14. The optical system according to claim 1, further comprising a light source and a light detection system, the optical system being configured for multiphoton microscopy.

15-16. (canceled)

17. The optical system according to claim 9, further comprising a light source, a light detection system, and a data processor configured to receive light detection data from said light detection system and stage position data from said controller and to provide optical sectioning of a sample, wherein each optical section corresponds to a different depth in said sample.

18. The optical system according to claim 1, being configured for multiphoton manipulation.

19. The optical system according to claim 1, being configured for material processing.

20. The optical system according to claim 1, being configured for photolithography.

21. The optical system according to claim 1, being configured for photoablation.

22. The optical system according to claim 1, being configured for neuron stimulation.

23. The optical system according to claim 1, being configured for three-dimensional optical data storage.

24. An optical system, comprising:
a beam splitting arrangement configured for split an input light beam pulse to a plurality of secondary light beams propagating along a separate optical path;
a temporal focusing optical system configured for receiving each of said secondary light beams and for controlling a temporal profile of a respective pulse to form an intensity peak at a separate focal plane.

25-26. (canceled)

27. A system for multiphoton microscopy, comprising:
a light source, an objective lens, a collimator, a first optical set having at least a prismatic optical element, a second optical set having at least one lens, and an optical switching system;
wherein said first optical set is configured for effecting temporal focusing at a focal plane near said objective, said second optical set is configured for effecting only spatial focusing at said focal plane; and
wherein said switching optical system is configured for deflecting an input light beam to establish an optical path either through said first optical set or through said second optical set.

28-33. (canceled)

34. A method of imaging a sample, comprising:
acquiring a first depth image of the sample using multiphoton laser scanning microscopy;
acquiring a second depth image of the sample using multiphoton temporal focusing microscopy;
using said first depth image to calculate a transfer matrix describing a relation between individual elements of the sample and said first depth image; and
processing said second depth image using said transfer matrix.
